(19) United States
(12) Patent Application Publication
(10) Pub. No.: US 2026/0015834 A1
(43) Pub. Date: Jan. 15, 2026

(54) CALIBRATION AND SETUP FOR A MACHINE GUIDANCE SYSTEM

(71) Applicant: EQUIPMENTSHARE.COM INC, Columbia, MO (US)

(72) Inventors: James Dianics, San Diego, CA (US); Shane Trimble, Dublin (IE); Seth Kasmann, Columbia, MO (US); David Pasley, Topeka, KS (US); Rob Martin, Columbia, MO (US); Sheila Bagley, Columbia, MO (US)

(21) Appl. No.: 19/268,734

(22) Filed: Jul. 14, 2025

Related U.S. Application Data
(60) Provisional application No. 63/671,519, filed on Jul. 15, 2024.

(51) Int. Cl. E02F 9/26; E02F 9/20; E02F 9/24; G01S 7/497; G01S 17/89; G01S 17/931

(52) U.S. Cl. CPC E02F 9/265; E02F 9/205; E02F 9/24; E02F 9/262; G01S 7/497; G01S 17/89; G01S 17/931

(57) ABSTRACT

A system and method for calibrating and setting up a machine guidance system for construction assets, such as loaders or excavators, employ point cloud data from onboard optical sensors to acquire spatial measurements. Point cloud data is transformed to an asset coordinate frame, candidate pitch and roll offset values are applied, grid representations are generated, and calibration values are selected with reduced error by comparing these grids to a reference surface. The system and method support autonomous operations including obstacle avoidance and grading by modifying the point cloud data according to the determined calibration values. In addition, dual-sensor calibration, terrain mapping, and filtering techniques are disclosed.

### CROSS-REFERENCE TO RELATED APPLICATIONS

This application claims priority to U.S. Provisional Application No. 63/671,519 (filed 15 Jul. 2024). This application is related to U.S. patent application Ser. No. ______ (Docket Nos. EQS-003US1 and 661-0103US1); Ser. No. ______ (Docket Nos. EQS-003US2 and 661-0103US2); and Ser. No. ______ (Docket Nos. EQS-003US4 and 661-0103US4) (filed concurrently with this application). The entire disclosures of these applications are incorporated herein by reference.

### TECHNICAL FIELD

The inventive subject matter described herein relates to systems and methods for asset guidance, and more specifically, to techniques for rapid, intuitive, and robust calibration and setup of machine guidance systems used for self-propelled assets (such as construction or earthmoving vehicles) and their attachments. The inventive subject matter enables the guidance systems for these assets to efficiently configure, recalibrate, and validate the operational status of sensors and attachments. This allows easier transitions between different attachments and can ensure accurate, reliable operation in dynamic and challenging worksite environments.

### BACKGROUND

Construction vehicles play an important role in modern construction, where heavy machinery such as loaders, excavators, and dozers are routinely employed for earthmoving and material handling. Construction and related fields of work involve different tasks that are performed by different types of construction vehicles. Typical construction vehicles include loaders, excavators, compactors, and other earthmoving vehicles, any combination of which may be used at a work site. These vehicles incorporate various moveable components that are necessary for performing a range of tasks. For example, some construction vehicles have arms, appendages, attachments, or other moveable parts that can be manipulated during operation of the vehicle. For example, a loader includes a main body connected to a lift arm that can be raised and lowered, which in turn is connected to one of various attachments (such as a bucket attachment, a mower attachment, etc.).

In recent years, efforts have increased to integrate advanced sensing technologies and guidance systems into these machines. These systems are designed to improve operational efficiency and safety by providing real-time positional and orientation information to operators, which can support tasks such as attachment manipulation and grade control. The field of vehicle guidance continues to evolve as manufacturers and researchers seek to improve the integration of data from multiple sensors to offer more comprehensive support during machine operation.

A primary objective of guidance systems in this sector is to provide accurate, real-time information that facilitates precise control over machine movements and interactions with the surrounding environment. Modern construction operations demand tools that can help operators maintain desired work parameters, such as consistent grade and alignment, while also managing complex site conditions. Such systems work to combine data from various sensors to generate actionable feedback that improves productivity, reduces operator workload, and enhances jobsite safety.

Despite considerable progress, many conventional guidance solutions encounter significant challenges within harsh construction environments. Traditional systems often depend on wired components that are vulnerable to damage from vibration, dust, and adverse weather conditions. These vulnerabilities can lead to intermittent sensor failures and reduced measurement accuracy. In addition, systems that rely on disparate sensor data frequently struggle with issues related to calibration, synchronization, and data fusion, all of which can compromise the overall reliability of the positional information. As a result, operators may face inconsistent feedback about machine movements and environmental factors, hindering the ability to maintain precise control under dynamic worksite conditions.

Operators have also experienced difficulties in managing the complexities associated with rapidly changing construction environments and varied attachment configurations. Many guidance systems do not adequately address the need for simultaneous monitoring of vehicle dynamics and real-time terrain conditions. This shortcoming can result in limited situational awareness, where critical information regarding obstacles and uneven surfaces is either delayed or inaccurate.

Moreover, traditional approaches frequently require manual calibration or intervention when switching between different attachments or when environmental conditions change, which can lead to operational inefficiencies. Some known calibration and setup processes for machine guidance systems are complex, time-consuming, and error-prone. Some systems require manual measurement, specialized tools, or extensive technical expertise to perform initial calibration or to recalibrate when attachments are changed or sensors are replaced. This process often involves multiple steps, such as entering geometric parameters, aligning reference points, and performing test movements, which can lead to significant downtime and operational inefficiency. Furthermore, in the harsh and dynamic environments typical of construction sites, sensors and attachments are frequently exposed to shocks, vibrations, dust, and debris, increasing the likelihood of misalignment or sensor drift and necessitating frequent recalibration.

As construction projects become more complex and demand greater flexibility, there is a growing need for machine guidance systems that can be quickly and intuitively calibrated and set up by operators in the field. Such systems should reduce or eliminate the need for specialized knowledge or equipment, support easy transitions between different attachments, and provide robust error detection and feedback to ensure ongoing accuracy and reliability.

Thus, there is a need for an improved calibration and setup system that enables rapid, user-friendly, and robust configuration of machine guidance systems and their attachments, reducing downtime, enhancing operational flexibility, and maintaining high levels of accuracy and safety in demanding construction environments.

### BRIEF SUMMARY OF THE DISCLOSURE

In one example, a computer-implemented method for calibrating and setting up a machine guidance system for a construction asset is provided. The method includes receiving point cloud data from an optical sensor onboard the asset. The point cloud data represents a sensed environment that includes a portion of the asset and surrounding terrain. The method includes transforming the point cloud data from a sensor coordinate frame to an asset coordinate frame, applying different candidate pitch and roll offset values to the point cloud data, generating a grid representation of the sensed environment for each of plural combinations of the candidate pitch and roll offset values, calculating a calibration error for each of the combinations of the candidate pitch and roll offset values by comparing each of the grid representations to a reference surface, and selecting the combination exhibiting a smaller value of the calibration errors and applying the pitch and roll calibration values associated with the smaller value of the calibration errors to the point cloud data output by the optical sensor during subsequent operation of the asset.

In another example, a machine guidance system for autonomously operating a construction asset is provided. The machine guidance system includes an optical sensor configured to be onboard the asset and to output point cloud data representative of a sensed environment that includes a portion of the asset and surrounding terrain. The machine guidance system also includes a processing unit configured to receive the point cloud data and transform the point cloud data from a sensor coordinate frame to an asset coordinate frame. The processing unit is configured to apply different candidate pitch and roll offset values to the point cloud data, generate a grid representation of the sensed environment for each of plural combinations of the candidate pitch and roll offset values, and calculate a calibration error for each of the combinations of the candidate pitch and roll offset values by comparing each of the grid representations to a reference surface. The processing unit is configured to select the combination exhibiting a smaller value of the calibration errors and apply the pitch and roll calibration values associated with the smaller value of the calibration errors to the point cloud data output by the optical sensor during subsequent operation of the asset.

In another example, a computer-implemented method for calibrating and setting up a machine guidance system for a construction asset is provided. The method includes receiving first point cloud data from a first LiDAR sensor onboard the asset and second point cloud data from a second LiDAR sensor onboard the asset. The first point cloud data and the second point cloud data represent a sensed environment that includes a portion of the asset and surrounding terrain. The method also includes transforming the first point cloud data and the second point cloud data from a sensor coordinate frame to an asset coordinate frame, applying different candidate pitch and roll offset values to the first point cloud data, generating a grid representation of the sensed environment for each of plural combinations of the candidate pitch and roll offset values, calculating a calibration error for each of the combinations of the candidate pitch and roll offset values by comparing each of the grid representations to a reference surface, selecting the combination exhibiting a smaller value of the calibration errors and applying the pitch and roll calibration values associated with the smaller value of the calibration errors to the first point cloud data output by the first LiDAR sensor during subsequent operation of the asset, calculating pitch, roll, yaw, and position calibration offset values for the second point cloud data by comparing the first point cloud data and the second point cloud data, receiving additional first point cloud data from the first LiDAR sensor and additional second point cloud data from the second LiDAR sensor while the asset is at least partially autonomously performing material handling or earthmoving, modifying the additional first point cloud data using the pitch and roll calibration values that are selected, modifying the additional second point cloud data using the pitch, roll, yaw, and position calibration offset values that are calculated, and autonomously changing movement of the asset or an attachment of the asset using the additional first point cloud data that is modified and the additional second point cloud data that is modified to one or more of avoid colliding with an obstacle or grade a worksite.

### BRIEF DESCRIPTION OF THE DRAWINGS

A detailed description of various embodiments of a machine guidance system deployed on a construction vehicle is provided below with reference to the following drawings, in which:

FIG. 1 illustrates one example embodiment of a machine guidance system;

FIG. 2 illustrates a flowchart of one example of a method for tracking a moveable part of an asset in relation to the surrounding terrain;

FIG. 3 is a perspective view of one example of the machine guidance system shown in FIG. 1 onboard an asset;

FIG. 4 is a top plan view of the machine guidance system and the asset shown in FIG. 3;

FIG. 5 illustrates a perspective view of a machine guidance assembly;

FIG. 6 illustrates a flowchart of one example of an initialization process;

FIG. 7 illustrates a flowchart of one example of the manufactured condition process;

FIG. 8 illustrates a flowchart of one example of an arm/attachment detection process; and

FIG. 9 shows an example mower attachment with attachment reflectors placed thereon.

### DETAILED DESCRIPTION OF EMBODIMENTS

The following detailed description provides various embodiments of a machine guidance system and method for tracking construction vehicles and their surrounding terrain. The described technology is directed toward improving the operation, guidance, and terrain mapping capabilities of construction vehicles, such as loaders, excavators, and other heavy machinery. By integrating advanced sensor technologies, data fusion techniques, and user interfaces, the described system enhances the precision, safety, and efficiency of construction operations.

Various examples of systems and methods for the calibration and setup of the machine guidance systems of assets such as construction vehicles, as well as of the attachments to the assets. The described technology generally relates to the rapid, intuitive, and robust configuration of machine guidance systems, including the initial calibration, recalibration, and validation of sensors and attachments on assets such as loaders, excavators, and dozers. While specific examples, hardware configurations, and operational sequences are described herein, these are provided for illustrative purposes only and are not intended to limit the scope of the invention unless expressly stated otherwise. For example, the calibration and setup systems and methods described herein may be used in connection with guidance systems used in connection with assets other than construction vehicles (e.g., automobiles, all terrain vehicles, etc.).

While various examples of a machine guidance system deployed on a construction vehicle are described herein, not all embodiments of the inventive subject matter are limited to the specific configuration or methodologies of any of these embodiments unless explicitly recited or stated. Additionally, although the examples are described as embodying several different inventive features, any one of these features could be implemented without the others and that the inventive subject is not limited to any particular combination of features unless explicitly recited or stated.

References to “one embodiment,” “an embodiment,” “an example embodiment,” or “embodiments” mean that the feature or features being described are included in at least one embodiment of a machine guidance system deployed on a construction vehicle. Separate references to “one embodiment, “an embodiment, “an example embodiment,” or “embodiments” in this disclosure do not necessarily refer to the same embodiment and are also not mutually exclusive unless so stated and/or except as will be readily apparent to one of ordinary skill in the art from the disclosure. For example, a feature, structure, function, etc. described in one embodiment may also be included in other embodiments, but is not necessarily included. Thus, a machine guidance system or method can include a variety of combinations and/or integrations of the features, structures, functions, etc. described herein.

The construction industry depends extensively on vehicles such as loaders, excavators, and dozers to carry out a variety of tasks, including earthmoving, grading, and material handling. These vehicles often incorporate moveable components, such as lift arms and attachments, which demand precise control and monitoring to maintain operational efficiency and safety. Traditional machine guidance systems, while providing some degree of assistance, face notable challenges. Many utilize wired components, which can be susceptible to failure in demanding construction environments characterized by vibration, dust, and debris. Moreover, these systems frequently struggle to adapt seamlessly to different attachments, necessitating time-consuming recalibration or manual adjustments when switching between tools. Additionally, conventional systems generally emphasize providing positional data for the vehicle or its attachments but often overlook the surrounding terrain or obstacles, limiting operators' situational awareness and increasing the likelihood of errors or accidents.

The described technology addresses these shortcomings by introducing an advanced machine guidance system that integrates multiple sensing technologies, data fusion algorithms, and real-time terrain mapping capabilities. A combination of optical sensors (e.g., LiDAR), location sensors (e.g., GNSS antennas and receivers), and movement sensors (e.g., inertial measurement units (IMUs)) is used to track the position and orientation of moveable parts of a construction vehicle with high precision. Unlike some known systems, the described technology eliminates the need for vulnerable wired components by utilizing passive reflectors on the vehicle's attachments, which reflect light pulses emitted by the optical sensors. This design enhances durability and simplifies the process of switching attachments, as the machine guidance system can be efficiently recalibrated by placing reflectors on new tools and performing reduced setup steps.

The guidance system further distinguishes itself through the capability to generate real-time terrain maps and identify obstacles in the vehicle's environment. By fusing point cloud data from the optical sensors with location and movement data, the processing unit creates a comprehensive spatial model that incorporates both the vehicle's position and the surrounding terrain. Advanced filtering techniques, such as box filters and reflectivity-based thresholds, can be used to ensure that the system remains robust even in dusty or debris-filled environments. The terrain mapping functionality enables operators to visualize the vehicle's position in relation to the terrain and obstacles, enhancing situational awareness and supporting safer, more efficient operations. Additionally, the modular architecture of the guidance system allows deployment across a wide range of construction vehicles, including loaders and excavators, and supports both manual and autonomous operation modes.

In summary, the inventive machine guidance system overcomes the limitations of traditional approaches by combining durable hardware configurations, advanced sensor fusion, and real-time environmental awareness. This integrated solution not only enhances the precision and reliability of vehicle guidance but also provides operators with actionable insights into their surroundings, enabling safer and more efficient construction workflows.

The subject matter described herein relates to machine guidance systems deployed on assets such as construction vehicles. In some examples, the machine guidance system is used to track one or more than one moveable part of the asset and generate guidance information to assist in operation of the asset. In some embodiments, the machine guidance system or method is also used to generate a map of an area of terrain surrounding the asset and generate terrain mapping information to enable display of the asset in relation to the surrounding terrain. A variety of different types of assets may be operated using the machine guidance system, such as loaders (for example, track loaders), excavators, compactors, backhoes, dozers, etc. Other types of assets that may be operated using the machine guidance system will be apparent to one of ordinary skill in the art.

The assets may be manually operated, autonomously operated, semi-autonomously operated, or may alternate between autonomous operation mode and manual operation mode. The guidance and/or terrain mapping information is provided to an operator of the asset via a human machine interface (HMI) as part of the guidance system. The guidance and/or terrain mapping information can be provided to a control system that is deployed within the asset or that is remote from the asset. This can allow for the asset to be remotely monitored and/or controlled from afar.

### I. Machine Guidance System

The machine guidance system disclosed herein may be deployed on a variety of different types of assets. The machine guidance system includes a processing unit configured to process sensor data provided by a sensor suite. The processing unit uses the processed sensor data to track the position of one or more than one moveable part of an asset. The processing unit can generate a map of an area of terrain surrounding the asset. The sensor suite may include one or more than one sensors, such as an optical sensor detecting and tracking one or more than one moveable parts of the asset. The sensor suite can include a position sensor such as a global navigation satellite system (GNSS) receiver (e.g., a global positioning system (GPS) navigation system) for determining the position of a GNSS antenna mounted on the asset. The sensor suite can include a movement sensor that determines acceleration (e.g., linear acceleration), angular velocity, and/or heading or orientation. One example of such as sensor is an inertial measurement unit (IMU) sensor for providing data relating to the rotation of the asset. For example, the IMU can provide linear and angular acceleration which are indicative (through calculus) of the orientation of the asset. The sensor suite can include a single sensor or multiple sensors. With respect to multiple sensors, the sensor suite can include at least one of each of two or more different sensors, or may include multiple sensors but less than all of the sensors described herein.

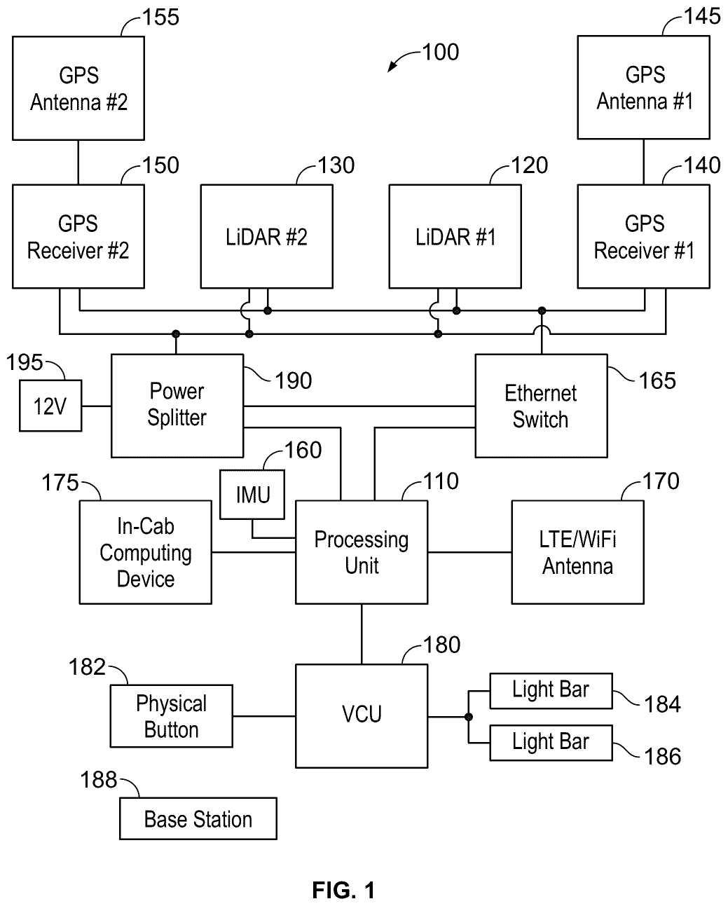

FIG. 1 illustrates one example embodiment of a machine guidance system 100. The machine guidance system 100 includes a processing unit 110. The processing unit 110 represents hardware circuitry that includes and/or is connected with one or more than one processors (e.g., integrated circuits, application-specific integrated circuits, field programmable gate arrays, graphics processing units, etc.) that perform the operations described in connection with the processing unit 110. If the processing unit 110 includes multiple processors, then the actions or operations performed by the processing unit 110 may be performed by each of the processors, or different processors may perform different actions or operations.

a. Optical Sensors

The machine guidance system 100 also includes one or more than one optical sensor 120, 130. The optical sensors 120, 130 track moveable parts, map terrain, and/or detect obstacles. These optical sensors 120, 130 can incudes LiDAR sensors, but in some embodiments can include stereo cameras, monocular cameras, time-of-flight (ToF) cameras, infrared (IR) sensors, radar sensors, or the like. The machine guidance system 100 includes one or more than one position sensors such as Global Navigation Satellite System (GNSS) receivers 140, 150 each respectively connected to a GNSS antenna 145, 155. The machine guidance system 100 includes a movement sensor 160, such as an inertial measurement unit (IMU) sensor. The movement sensor 160 may be included or onboard the processing unit 110, or may be separate from (but communicate with) the processing unit 110. The machine guidance system 100 in some embodiments includes a communication network device 165 that serves as a switch or connection between multiple computing devices. One example of such a network device 165 includes an Ethernet switch. The guidance system 100 can include a communication device 170 (e.g., a cellular or WiFi antenna), an onboard computing device 175, a vehicle control unit (VCU) 180 connected to an input device 182 and output devices 184, 186, and a power splitter 190 connected to a power adapter 195. The VCU 180 optionally can be referred to as an asset control unit (ACU) 180. The asset on which the machine guidance system 100 is deployed may be manufactured with these components, or one or more of these components may be later added to the asset (e.g., via upfitting). The output devices 184, 186 can be used to provide guidance information to the operator visually, audibly, tacitly and/or otherwise during operation of the asset. The aforementioned components may be separate components, or two or more (or all) of these components may be included in a single device.

The optical sensors 120, 130 are mounted at different location on the asset. In some embodiments, a single optical sensor 120 or 130 may be used, or more than two optical sensors 120, 130 may be used. One optical sensor 120 or 130 may be used to reduce the overall production cost of the machine guidance system 100, while three or more optical sensors 120, 130 may be used to provide redundancy. For example, a third or fourth (or more) optical sensor 120 and/or 130 may be included in the machine guidance system 100. If an optical sensor 120 or 130 fails, then the third or fourth (or other) optical sensor may be used in place of the failed optical sensor 120 or 130. As another example, data may be received from each of the three or more optical sensors 120, 130 and used for redundancy purposes. Two optical sensors 120, 130 are used in the illustrated example to provide a continuous 360 degree view around the asset (without the asset having to turn or rotate to provide the 360 degree view).

Optionally, a single optical sensor 120 or 130 may be used, or more than two optical sensors 120, 130 may be used. Each of the optical sensors 120, 130 can generate optical data representative of objects (or the absence of objects) within fields of view of the optical sensors 120, 130. With respect to LiDAR sensors, the optical sensors 120, 130 generate point cloud data based on light pulses emitted and reflected back from moveable parts of the asset. For example, the asset may include reflective surfaces or reflective objects (e.g., stickers, panels, etc.) may be affixed to the moveable parts of the asset. For example, if the construction vehicle is a loader, a reflector may be placed on the lift arm of the loader and a reflector may be placed on an attachment attached to the lift arm of the loader. The reflectors may be passive devices that reflect light back to the optical sensors 120, 130. For example, the reflectors may be retroreflectors that are not powered, and do not require power (electrical or otherwise), to operate. The reflectors may not be wired or otherwise conductively coupled with any power source. The reflectors may be tape, sheeting or other material with a reflective surface that is suitable for reflecting light back to a LiDAR sensor, such as the white aluminum foil tape. However, other optical sensors 120, 130 may be used, and other reflectors or no reflectors may be used.

The non-wired reflective surfaces (e.g., tape or plates) placed on moveable parts of the asset eliminates vulnerabilities or failure points associated with wired systems, such as damage from vibration, dust, or debris. This can help the machine guidance system 100 operate in harsh construction environments. In general, a harsh construction environment is a worksite characterized by challenging or extreme physical conditions that can impact the safety of workers, the durability of materials, and the overall progress and success of the project.

b. Asset Control Unit (ACU)

The ACU 180 or the processing unit 110 actively controls or limits the movement of the asset based on obstacle detection and terrain mapping to ensure safe and efficient operation. The ACU 180 represents the central processing and control module of the asset. The ACU 180 represents hardware circuitry that includes and/or is connected with one or more processors (e.g., one or more integrated circuits, application-specific integrated circuits, field programmable gate arrays, etc.) that perform the operations described herein in connection with the ACU 180. The processing unit 110 communicates with the ACU 180 of the asset. The asset control unit 180 is the central processing and control system integrated into the asset. The asset control unit 180 serves as the primary interface between the hardware components of the asset (e.g., sensors, actuators, and attachments) and the operator. The asset control unit 180 in some embodiments can autonomously or semi-autonomously control operation of the asset based on data and signals provided by the processing unit 110.

The ACU 180 receives input from the operator via the input device 182 and/or from the processing unit 110, with this input directing changes in movement of the asset, positions of arms of the asset, and/or positions/orientations of the attachment. For example, the ACU 180 can control cylinders, motors, engines, or the like, to move the asset, asset arms, and/or asset attachment based on input from the processing unit 110 and/or operator (e.g., through the input device 182).

Actuators, such as hydraulic cylinders, pneumatic cylinders, electric motors, or the like, onboard the asset are controlled by the processing unit 110 and/or ACU 180 adjust the tilt and/or position of the attachment to align the attachment (e.g., the cutting edge of a bucket) with the calculated slope and/or cross-slope parameters. The processing unit 110 and/or ACU 180 can modify the moving speed and trajectory of the asset to maintain consistent operation of the attachment along the slope and cross-slope.

Using real-time data from the optical sensors 120, 130, location sensors, and/or the movement sensor 160, the processing unit 110 identifies obstacles and differentiates the obstacles from terrain features while the asset is moving and/or stationary. If an obstacle is detected within the planned path of movement of the asset or within a threshold distance of the asset, the processing unit 110 or the ACU 180 can calculate an alternative route or stop the movement to prevent collisions and/or generate an alert to warn the operator (e.g., using sound generated via a speaker, flashes on the output devices 184, 186, or the like). Similarly, the terrain mapping data is analyzed to identify hazardous conditions, such as steep slopes, uneven surfaces, or unstable ground. The ACU 180 or processing unit 110 uses this information to dynamically adjust the speed, direction, and attachment positions of the asset. For example, the ACU 180 may limit the speed of the asset when approaching a steep incline or prevent the bucket or blade attachment from moving beyond a safe range of motion when operating near an obstacle. By integrating obstacle detection and terrain mapping with the ACU 180 or processing unit 110, the ACU 180 or processing unit 110 ensures that the asset operates within safe parameters, reducing the risk of accidents and improving overall operational efficiency.

c. Location Sensors

The location sensors (e.g., the GNSS antennas 145, 155 and associated receivers 140, 150) can be mounted at different locations on the asset. Each of the GNSS antennas 145, 155 receives and, in some embodiments, amplifies signals transmitted or broadcast by GNSS satellites and converts the signals for use by the GNSS receivers 140, 150. The GNSS receivers 140, 150 analyze the received signals to determine the positions of the GNSS antennas 145, 155. In one example, one GNSS antenna 145 serves as a system reference point for the machine guidance system 100, and another GNSS antenna 155 is used to determine heading and/or pitch of the asset. The GNSS receivers 140, 150 use real-time kinematics (RTK) positioning technology to provide more precise position information in one example.

The machine guidance system 100 may include two GNSS antennas 145, 155 mounted on the asset or may include more than two GNSS antennas 145, 155. The GNSS antennas 145, 155 and GNSS receivers 140, 150 work together to provide precise positional, heading, and pitch information for the asset. The GNSS antennas 145, 155 can be placed on the asset to serve distinct but complementary purposes. One GNSS antenna 145 can be placed closer to a front or leading edge of the asset and operate as the primary reference point for the machine guidance system 100. The signals received by this front GNSS antenna 145 are examined by the GNSS receiver 140 to provide the absolute position of the asset (e.g., in a global coordinate system, such as latitude, longitude, and altitude. This GNSS antenna 145 serves as the fixed reference for calculating heading and pitch when combined with data from the rear GNSS antenna 155. The front GNSS antenna 145 can be mounted on a stable, fixed part of the asset, typically near the front or center of the body of the asset.

The other GNSS antenna 155 can be mounted on the asset farther from the front than the front GNSS antenna 145 (and closer to the opposite back of the asset than the front GNSS antenna 145). The rear GNSS antenna 155 can be mounted on a moveable or rear part of the asset, such as the rear linkage or a stable rear section of the asset. The rear GNSS antenna 155 works with the front GNSS antenna 145 to calculate heading and pitch of the asset. The rear GNSS antenna 155 measures the relative position of the rear of the asset compared to the front. The rear GNSS antenna 155 provides signals to the GNSS receiver 150, which uses the signals to calculate the heading (e.g., the direction of travel) of the asset by calculating the angle between the two GNSS antennas 145, 155. The GNSS receiver 150 also can calculate the pitch of the asset (e.g., the tilt of the asset along its longitudinal axis) by comparing the vertical displacement between the two GNSS antennas 145, 155.

In some embodiments, the machine guidance system 100 does not include the GNSS receivers 140, 150 and/or antennas 145, 155. In these embodiments, the machine guidance system 100 uses other techniques to determine the real-world geographic position of the asset. For example, the machine guidance system 100 can include one or more than one reflector positioned at a known location. The optical sensor 120 and/or the optical sensor 130 generate point cloud data based on the light pulses emitted and reflected back from that reflector to determine the position of the optical sensor 120 and/or the optical sensor 130 and, therefore, the location of the asset relative to the reflector. Because the reflector location is known, the location of the asset relative to the reflector can then be converted into the location of the asset.

d. Movement Sensor

The movement sensor 160 is mounted on the asset and provides data relating to movement of the asset, such as rotation of the asset. This data can be repeatedly provided by the movement sensor 160 (e.g., to the processing unit 110), such as in a continuous stream or otherwise repeated stream of data. The movement sensor 160 can output signals indicative of roll, pitch, and/or yaw rotation of the asset. The movement sensor 160 can be mounted at or close to the center of rotation of the asset, or in another location.

e. Processing Unit

The processing unit 110 receives sensor data from the sensors of the machine guidance system 100 via the network device 165. The network device 165 (e.g., an Ethernet switch) manages the flow of sensor data from the optical sensors 120, 130, the movement sensor 160, and/or the location sensors (e.g., the receivers 140, 150) to the processing unit 110. The network device 165 may be a ruggedized gigabit Ethernet switch, although other components capable of performing packet switching (e.g., in accordance with the Ethernet or Industrial Ethernet (IE) standard) may be used.

### 1. Data Fusion

The processing unit 110 fuses or otherwise combines the sensor data received from the sensors in the sensor suite (e.g., the optical sensors 120, 130, the GNSS receivers 140, 150, the GNSS antennas 145, 155, and/or the movement sensor 160). The processing unit 110 uses the fused data to track moveable parts of the asset in relation to the surrounding terrain. The processing unit 110 uses the fused data to provide guidance and/or terrain mapping information to an operator of the asset.

The GNSS receivers 140, 150 provide real-time positional data for the asset. This allows for the processing unit 110 to precisely track the location of the asset at a worksite. This is useful for tasks such as mapping the terrain, defining work boundaries, and ensuring accurate excavation or grading. The heading of the asset can be used by the processing unit 110 to maintain alignment of the asset during operations such as trenching, grading, or material placement. The pitch of the asset can be used by the processing unit 110 to maintain proper blade or bucket angles, and ensure accurate grade control. The GNSS data can be fused with data from other sensors, such as the optical sensors 120, 130 and/or the movement sensor 160, to comprehensively track the position, orientation, and movement of the asset. This fusion improves the accuracy and reliability of the machine guidance system 100, especially during operation on dynamic or uneven terrain.

Using multiple GNSS antennas 145, 155 can provide more precise heading and pitch calculations compared to a single GNSS device. The combination of absolute positioning (e.g., using the front GNSS antenna 145) and relative positioning (e.g., using the rear GNSS antenna 155) allows for terrain mapping, grade control, obstacle avoidance, and the like.

Using the data output by dual or multiple GNSS antennas 145, 155 (e.g., front and rear antennas) in combination with the data output by the optical sensors 120, 130 can provide more precise positional, heading, and pitch information for the asset when compared with other machine guidance systems. For example, a dual location sensor configuration enables real-time tracking of the orientation and movement of the asset, which can be helpful for tasks such as grade control and terrain mapping. The dual location sensor setup provides increased accuracy for heading and pitch calculations compared to machine guidance systems that rely on single location sensors, while the integration with the optical sensors 120, 130 improves terrain mapping and obstacle detection.

2. Communication with Computing Devices

The processing unit 110 interfaces with the communication device 170 for communication with an off-board computing device over one or more than one computerized communication networks (e.g., a cellular network, a WiFi network, etc. This computing device 175 can be a mobile phone, tablet computer, laptop computer, or the like, which may be used by an operator to input set-up information. The set-up information may include the type of asset and attachment to be operated with the assistance of the machine guidance system 100 and, in some embodiments, may also include one or more than one operating parameters to be used by the machine guidance system 100.

The processing unit 110 communicates with the onboard computing device 175 that can be located within the cab of the asset or on the roof of the asset. The onboard computing device 175 can be a mobile phone, a tablet computer, a laptop computer, or the like. The onboard computing device 175 may display various guidance information and maps that can be viewed by the operator during operation of the asset.

f. Input Devices and Output Devices

The processing unit 110 communicates with the asset control unit 180 of the asset. The asset control unit 180 is the central processing and control system integrated into the asset. The asset control unit 180 serves as the primary interface between the hardware components of the asset (e.g., sensors, actuators, and attachments) and the operator. The asset control unit 180 can, in some embodiments, autonomously and/or semi-autonomously control operation of the asset based on data and signals provided by the processing unit 110.

The asset control unit 180 controls actuators that adjust the position and movement of asset components, such as the position of a bucket or blade of the asset to provide proper alignment and grade control, the movement of arms of the asset, hydraulic pressures of the asset for control of the arms and attachments, and the like. The asset control unit 180 provides an operator interface and can output visual and/or audio feedback to the operator via displays, light bars, etc.

The asset control unit 180 interfaces with one or more than one input device 182 and one or more than one output device 184, 186, which may be located within the cab of the asset. The input device 182 may be a button, switch, lever, selectable icon on a graphical user interface, etc. The input device 182 can be used by the operator to input information during the set-up process. In another example, the operator may input this information using the onboard computing device 175. The output devices 184, 186 visually convey positional feedback information to the operator. For example, the output devices 184, 186 may be elongated displays or lamps (e.g., light bars) that illuminate to communicate positions of the asset, portions of the asset (e.g., arms of the skid steer loader), and/or attachments (e.g., a bucket connected to the arms). The output devices 184, 186 are elongated LED light bars used to provide guidance information to the operator during operation of the asset, as described above. During the set-up process, the output devices 184, 186 may be configured to operate in different modes, such as a standard mode, a dual mode, or a quad mode, as described herein. The onboard computing device 175 also can be an input and/or output device of the machine guidance system 100.

g. Base Station

The machine guidance system 100 also includes a base station 188. The base station 188 can be located off-board the asset, and may be a stationary component of the machine guidance system 100. For example, the base station 188 can be still while the asset moves at a worksite. The base station 188 may be moveable between different worksites (e.g., upon completion of work or usage of the machine guidance system 100 at one worksite, the base station 188 can be moved to another worksite).

The base station 188 can provide a fixed, high-accuracy reference point for the machine guidance system 100, such as for the GNSS receivers 140, 150 and the GNSS antennas 145, 155. The base station 188 can include (and/or the base station 188 shown in FIG. 1 can represent) one or more GNSS antennas (e.g., similar or identical to the antenna 145 and/or 155) and/or one or more GNSS receivers (e.g., similar or identical to the receiver 140 and/or 150). The base station 188 may include or be connected to a power supply, such as a generator, power utility grid, battery or battery cells, etc. The base station 188 can include one or more than one communication device for wirelessly communicating with the processing unit 110 of the machine guidance system 100 (e.g., via the communication device 170). The communication device of the base station 188 may be similar or identical to the communication device 170. The base station 188 can include a processing unit similar or identical to the processing unit 110 of the machine guidance system 100.

The GNSS antenna of the base station 188 receives GNSS satellite signals that are used by the GNSS receiver of the base station 188 to calculate a geographic location (e.g., longitude, latitude, and/or altitude) of the base station 188. The processing unit of the base station 188 may communicate with the processing unit 110 of the machine guidance system 100, compare locations determined by the GNSS receivers 140 and/or 150 of the machine guidance system 100 and determined by the GNSS receiver of the base station 188, and decide whether the machine guidance system 100 is within a threshold distance limit from the base station 188. For example, the processing unit 110 of the machine guidance system 100 may not permit autonomous or semi-autonomous operation of the asset, terrain mapping or updating of terrain maps, etc. if the machine guidance system 100 (and, therefore, the asset) are more than five miles from each other (as one example, although other distances may be used).

The processing unit of the base station 188 can receive a designated location (e.g., longitude, latitude, and/or altitude) from an operator of the machine guidance system 100 or from another source (e.g., output from a survey of a worksite). The processing unit of the base station 188 compares this input location and compare the input location with the location calculated using the GNSS satellite signals received by the GNSS antenna of the base station 188. The processing unit of the base station 188 can calculate a difference, or error, between these locations. A correction can be calculated based on this difference, such as values to add or subtract to the longitude, latitude, and/or altitude values calculated by the GNSS receiver of the base station 188. This correction can be communicated from the base station 188 to the processing unit 110 of the machine guidance system 100. The processing unit 110 can then apply the correction to locations calculated by the GNSS receiver(s) 140, 150 of the machine guidance system 100 to ensure that any errors in the locations determined from the GNSS satellite signals are corrected.

In another example, the base station 188 may be mobile. For example, the base station 188 may include or be on wheels, tracks, or the like, for self-propelling or being moved (manually or with the aid of the asset or another vehicle). In another example, the base station 188 may be part of or coupled to a stationary object, such as a building or another structure. As another example, one of the GNSS antennas 145, 155 can receive signals for establishing the reference location described above.

### II. Tracking Process

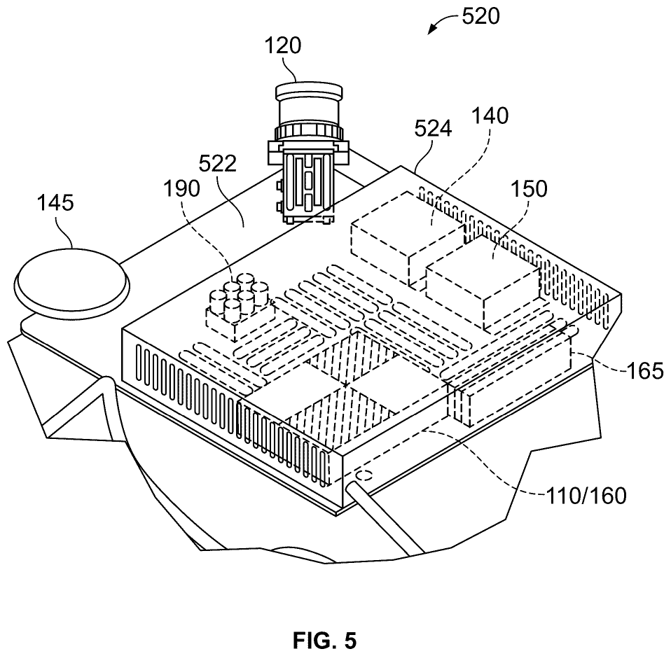

FIG. 5 illustrates a flowchart of one example of a method 200 for tracking a moveable part of an asset in relation to the surrounding terrain. While the operations of the method 200 are generally described with respect to FIG. 1, the operations may otherwise be performed.. The method 200 can be used to track the cutting edge of a bucket attachment of a loader during the performance of grading (e.g., the process of shaping and leveling the ground before building). The method 200 can be used to position the cutting edge of the bucket attachment at a desired elevation relative to the elevation of the terrain. In some embodiments, the method 200 may be used in connection with other assets and/or attachments to perform different tasks.

The method 200 includes parallel processing operations—for example, the sensor data collection operations 202, 204, and/or 206 can be performed in parallel or during overlapping time periods, the sensor data processing operations 208, 210, and/or 212 can be performed in parallel or during overlapping time periods, the arm/attachment reflector and terrain detection operations 214 and 216 can be performed in parallel or during overlapping time periods, the terrain and vehicle transform and cutting edge kinematics operations 222, 220, and/or 218 can be performed in parallel or during overlapping time periods, the operations 224 and 226 relating to the display of cutting edge and terrain elevations via a user interface (e.g., the onboard computing device 175 and/or light bars 184, 186) can be performed in parallel or during overlapping time periods.

a. Data Collection and Fusion

At 202, optical data related to reflectors on the asset are collected. For example, the optical sensors 120, 130 can generate point cloud data based on light pulses emitted and reflected back from a reflector placed on a lift arm of the asset and/or another reflector placed on the attachment connected to the lift arm (e.g., the bucket attached to the lift arm). At 204, movement data representative of movement of the asset is generated. For example, the movement sensor 160 can generate movement data indicative of movement of the asset. This data can include roll, pitch, and/or yaw rotation parameters for the asset. At 206, location data is obtained and used to determine positions. For example, the GNSS receivers 140, 150 can analyze electrical signals received from the GNSS antennas 145, 155, respectively, to determine the positions of the GNSS antennas 145, 155. In some embodiments, the location sensors use RTK positioning technology to provide more precise position information about the asset (such as CEP accuracy of about one centimeter).

At 208, 210, and 212, data is fused and processed. For example, the processing unit 110 can process the point cloud data provided by the optical sensors 120, 130 (at 208), process the movement data provided by the movement sensor 160 (at 210), and process the position data provided by the GNSS receivers 140, 150 (at 212). In some embodiments, less than all of this data is processed. The data can be processed by receiving and fusing the different sensor data based on the timestamps associated with the sensor data. For example, point cloud data, IMU data, and GNSS data may be fused (e.g., combined or associated with each other) if the respective timestamps are within a specified tolerance of each other. As another example, one or more Kalman filters or complimentary filters can be used to fuse the data. If one of the sensors 120, 130, 160, GNSS antennas 145, 155, and/or GNSS receivers 140, 150 fails or generates data that is outside of an acceptable range of values, the processing unit 110 can fuse the data from the remaining sensors 120, 130, 160, GNSS antennas 145, 155, and/or GNSS receivers 140, 150 by replacing the data from the failed sensors 120, 130, 160, GNSS antennas 145, 155, and/or GNSS receivers 140, 150 with data from another one of the sensors 120, 130, 160, GNSS antennas 145, 155, and/or GNSS receivers 140, 150 that has not failed. For example, if a GNSS antenna 145, 155 or GNSS receiver 140, 150 fails, the processing unit 110 can use data from the movement sensor 160 to replace the movement, velocity, pitch, etc. data that otherwise may have been obtained by the failed GNSS antenna 145, 155 and/or GNSS receiver 140 and/or 150.

b. Reflector Position Calculations

At 214, the position of one or more than one reflector on part of the asset is or are determined. For example, the processing unit 110 can analyze the optical data (from 208) to detect the position of a first reflector placed on part of the arm of the asset and the position of a second reflector placed on the attachment that is connected with (and separately moveable from) the arm. The positions of the first and second reflectors may be detected, for example, by calculating the centroids of the reflectors from the optical data. As another example, the positions of the first and/or second reflectors may be identified by manually measuring the position(s) of the first and/or second reflectors.

The method 200 can include filtering data at 214. For example, the processing unit 110 can filter out data points having reflectivity or signal values below a predetermined threshold. This can make the method 200 and system 100 robust to dust in the environment. For example, the method 200 can disregard weak or low-quality signals that may result from environmental factors such as dust, fog, or other airborne particulates that can scatter or attenuate light signals. By applying this filtering mechanism, the method 200 ensures that only stronger, more reliable data points are used for tasks such as terrain mapping, obstacle detection, and tracking of moveable parts. For example, the reflectivity values of the data points may vary between a lower or minimum value and an upper or maximum value. The predetermined threshold used to filter out data points having lower reflectivity values may be 50% of the upper or maximum value, 60% of the upper or maximum value, or another percentage. This allows the method 200 to maintain accurate and consistent performance even in harsh or dusty environments commonly encountered on construction sites. The filtering process reduces noise in the data, improving the overall reliability and precision of the method 200.

As another example, the processing unit 110 (at 214) can use one or more than one box filter to filter out data points that are not associated with the reflectors (given the known positions of the reflectors in relation to the known position of the front antenna 145, which serves as a system reference point). The box filter can be a spatial filter that applies a uniform averaging operation over a defined region, or box, of data points. The processing unit 110 defines a rectangular or cubic region around a target data point in a dataset, such as a 3D point cloud, received from the optical sensor(s) 120, 130.

An operation such as averaging or summing is applied to these data points within the box to calculate an output value for the target point (e.g., the reflector in the point cloud). The size of the box (e.g., the width, height, and depth of the box) determines the range of data points included in the operation. The size of the box can be adjusted based on the specific requirements of the application, such as the density of the point cloud or the level of noise in the environment. The box filter smooths the point cloud data by averaging the values of points within the defined box. This helps to reduce random noise caused by environmental factors such as dust, debris, or sensor inaccuracies. The filter can exclude outlier points that deviate significantly from the surrounding data. For example, points with unusually high or low reflectivity values may be removed to improve the accuracy of terrain mapping and obstacle detection.

By aggregating data within the box, the filter reduces the overall complexity of the optical data (e.g., the point cloud). The box filter can be used by the processing unit 110 to isolate and enhance data points associated with reflectors placed on moveable parts of the asset. By focusing on points within a specific region, the processing unit 110 can more accurately track the position and orientation of the arm and/or attachment of the asset.

In some examples, the processing unit 110 (at 214) compares the number of filtered data points to a number of points expected to be returned by each reflector and/or GNSS receiver 140, 150 to detect one or more than one error. For example, the processing unit 110 determines that the number of filtered data points (or the average or sum of the filtered data points) indicates an error when the number, average, or sum falls below a lower threshold. The errors that can be identified by the processing unit 110 in this way can be an object blocking the view between the optical sensor 120, 130 and the reflector, the reflector falling off the asset, damage to the reflector, a dirty optical sensor 120, 130, too much dust in the environment, a foreign reflective object close to the reflector, etc. If an error is detected, the processing unit 110 can return an error message so that the operator can identify and correct the error. In one example, the processing unit 110 may prevent continued movement of the asset, the arm, and/or the attachment responsive to such an error being identified.

c. Terrain Mapping

At 216, the optical data is analyzed to detect terrain elevation around the asset and/or generate or update a terrain map showing obstacles near the asset. The processing unit 110 analyzes the point cloud data from 208 (and which may be filtered) to detect the elevation of the terrain surrounding the asset, as well as generate a terrain map that may include the presence of any obstacles near the asset.

The processing unit 110 (at 216) can segment the point cloud to separate or differentiate terrain points from non-terrain objects, such as vehicles, trees, or buildings. These operations can be performed using algorithms that classify points based on height, reflectivity, and/or clustering. For example, the processing unit 110 differentiates between obstacles and terrain features by analyzing the point cloud data generated by the optical sensors 120, 130, along with data from other sensors like the location sensors and the movement sensor 160. The processing unit 110 differentiates between obstacles and terrain features using segmentation, classification, and filtering techniques. The point cloud data represents the surrounding environment, including both terrain features (e.g., ground, slopes) and obstacles (e.g., rocks, equipment, personnel). The location data from the location sensors and the movement data from the movement sensor 160 indicate the position and orientation of the asset, which is used by the processing unit 110 to identify the relative location of detected objects.

The processing unit 110 (at 216) can preprocess the point cloud data by applying noise filter(s) and/or outlier removal (e.g., using box filters). The processing unit 110 segments the point cloud into distinct clusters or regions to isolate potential obstacles from the terrain. The processing unit 110 can use progressive morphological filtering or cloth simulation filtering to identify ground points, or points in the data cloud indicative of the terrain. This can involve the processing unit 110 analyzing the relative height of points and their spatial distribution to distinguish ground points (e.g., terrain) from elevated objects. The non-ground points are grouped into clusters by the processing unit 110 based on the spatial proximity of the points using clustering algorithms (e.g., density-based spatial clustering of applications with noise) or k-means. Each cluster can represent a potential obstacle or terrain feature.

For each cluster, the processing unit 110 (at 216) extracts features to help classify the cluster as an obstacle or a terrain feature. These extracted features can include the height of the cluster of data points above the ground. The processing unit 110 can identify objects that are significantly elevated above the ground as obstacles (e.g., data point clusters that are at least a threshold height above the ground). The processing unit 110 can examine the dimensions (e.g., width, height, and/or depth) and shape of the clusters to differentiate between obstacles and terrain. For example, small, irregularly shaped clusters may be identified by the processing unit 110 as obstacles (e.g., rocks or debris), while larger, flatter clusters may represent terrain features (e.g., slopes or embankments). The processing unit 110 can examine reflectivity values of the data points in the cluster. The data points having greater reflectivity may be identified as metallic objects (e.g., obstacles such as other equipment), while lower reflectivity data points may be identified as the terrain. The processing unit 110 can examine the data points in the clusters to determine whether the cluster(s) is or are moving. If a cluster is detected by the processing unit 110 to be moving (e.g., using temporal data from consecutive LiDAR scans), the processing unit 110 can identify that cluster as being an obstacle (e.g., a person, animal, or vehicle).

The processing unit 110 (at 216) can classify each cluster as either an obstacle or a terrain feature using machine learning and/or rule-based algorithms. The processing unit 110 can compare the data and values to predefined thresholds for this classification. For example, predefined thresholds for features like height, size, and reflectivity are used to classify clusters. Clusters having a height above a certain threshold (e.g., 0.5 meters) are classified as obstacles, while clusters with large, flat shapes are classified as terrain features. The processing unit 110 can use supervised learning models (e.g., decision trees, support vector machines, or neural networks) trained on labeled datasets to classify clusters based on extracted features. These models can learn complex patterns and improve classification accuracy over time.

The processing unit 110 (at 216) can use temporal data from consecutive LiDAR scans to refine the classification of clusters. Static objects (e.g., rocks, terrain features) have data points that remain in the same or substantially same location across multiple scans. Conversely, dynamic objects (e.g., personnel, vehicles) may have data points that change position over time and are classified as obstacles. The processing unit 110 can compare a current point cloud with previous scans to detect newly introduced objects, which may be identified as obstacles.

The processing unit 110 (at 216) can integrate or fuse data from other sensors to improve the cluster classification. For example, the processing unit 110 can use the movement data from the movement sensor 160 to account for the roll, pitch, and/or yaw of the asset. This helps the processing unit 110 correctly identify terrain features even while the asset is on uneven ground. The processing unit 110 can use GNSS location information to differentiate between stationary obstacles and terrain features in the context of the location of the asset.

The processing unit 110 (at 216) can repeatedly update the classification of clusters as new point cloud data is collected. For example, the processing unit 110 can dynamically change the classification of an object from a terrain feature to an obstacle responsive to the cluster starting to move in successive scans.

The processing unit 110 (at 216) can generate the terrain map by converting the processed point cloud data into a structured representation. The processing unit 110 divides the terrain into a grid of cells (e.g., a 2D raster grid). For each cell, the processing unit 110 calculates an average, minimum, or maximum elevation of the data points within each cell. If no points exist in a cell, interpolation methods (e.g., nearest neighbor or bilinear interpolation) can be used by the processing unit 110 to estimate the elevation for that cell. The terrain map may be smoothed using techniques such as Gaussian filtering to reduce abrupt changes and create a more realistic representation. The terrain map can be integrated into the machine guidance system 100 to assist with path planning, grade control, and obstacle avoidance.

The processing unit 110 (at 216) can repeatedly update the terrain map as new point cloud data is collected. For example, as the asset moves, new point cloud data is merged with the existing terrain map to provide real-time updates. The processing unit 110 can detect changes in the terrain (e.g., newly excavated areas or obstacles) by comparing the updated point cloud with the existing map.

The processing unit 110 (at 216) generates the terrain map as a three-dimensional terrain map in real-time (e.g., the terrain map is generated or updated as the data is collected without introducing additional delays outside of normal computer processing). This terrain map can be created using data from optical sensors 120, 130, location data from the location sensors, and movement data from the movement sensor 160. The processing unit 110 differentiates obstacles from terrain features using these data sources.

d. Position and Orientation Calculation

At 218, the location data from the location sensors and the movement data from the movement sensor 160 is analyzed to determine the real-world position and orientation of the asset. The processing unit 110 can analyze the GNSS data from 212 and the IMU data from 210 to determine the geographic position and orientation (or heading) of the asset in a coordinate frame, such as the north-east-down (NED) coordinate frame. At 220, the processing unit 110 analyzes the terrain data from 216 and the movement data from 210 to map the terrain surrounding the asset (including any detected obstacles) in the NED coordinate frame or another coordinate system.

At 222, the reflector data from 214 is analyzed along with known dimensions of the asset to determine the position and orientation of the arm of the asset and/or of the attachment, such as the cutting edge of the bucket attachment. The processing unit 110 can determine the positions and orientations using models that mathematically describe the asset configuration through the use of forward kinematics. This determination may be performed using models that mathematically describe the asset configuration through the use of forward kinematics. Forward kinematics as used by the processing unit 110 is a mathematical modeling approach to determine the position and orientation of the end effector (e.g., the cutting edge of a bucket attachment of the asset) based on the known geometry of the linkage of the asset and the measured joint parameters (such as angles and lengths) of the arm of the asset to which the bucket is attached. In the context of a construction asset, such as a loader or excavator, the bucket attachment is connected to the vehicle body through a series of rigid links (e.g., arms and booms) and joints (e.g., revolute or prismatic).

The linkage from the asset chassis to the bucket edge can be modeled as a serial kinematic chain. Each link and joint in the chain can be assigned a coordinate frame by the processing unit 110, and the relationship between adjacent frames is described by a transformation matrix. The revolute joints of the asset are characterized by joint angles (0), such as the angle of rotation of the boom or arm of the asset. The prismatic joints are characterized in the model by linear displacements (d), if there are any displacements. Several parameters can be assigned by the processing unit 110 to each link of the asset (e.g., each rigid portion of the arm or attachment), including the joint angle θ (theta) (e.g., the angle of rotation about a z-axis), the link offset d (e.g., the translation distance along the z-axis), the link length a (e.g., the length of the link along the x-axis), and the link twist angle α (e.g., the angle of rotation about the x-axis). The x-axis is the axis parallel to the ground and extending in a direction parallel to the path of travel, the y-axis is the axis parallel to the ground and extending in a direction perpendicular to the path of travel, and the z-axis is the axis perpendicular to the ground.

For each joint or link, the processing unit 110 can define or utilize a homogeneous transformation matrix Tᵢ as:

$${T}_{i} = [ \begin{matrix}cos {θ}_{i} & - sin {θ}_{i} cos {α}_{i} & sin {θ}_{i} sin {α}_{i} \\ sin {θ}_{i} & cos {θ}_{i} cos {α}_{i} & - cos {θ}_{i} sin {α}_{i} \\ 0 & sin {α}_{i} & cos {α}_{i} \\ 0 & 0 & 0\end{matrix} ]$$

This transformation matrix is provided as just one example. Other transformation matrices may be created or obtained for the same or other assets. The transformation matrix can be created during calibration of the machine guidance system 100. The processing unit 110 can repeatedly examine the point cloud data to determine whether the transformation matrix is no longer accurate. For example, the reflectors may be bumped or otherwise moved from prior positions on which the transformation matrix was created. If the data points as transformed by the transformation matrix indicate a change in the position or orientation of the attachment (e.g., the bucket edge) when the attachment is not moved or was returned to a known position or orientation (that does not match the position or orientation determined from the transformation matrix), then the processing unit 110 can alert the operator using the output devices 184, 186 and/or computing device 175. The transformation matrix can then be re-defined or calibrated.

The transformation from the asset base (e.g., the asset chassis) to the bucket edge is calculated by the processing unit 110 multiplying the individual transformation matrices in order:

$${T}_{base \to bucket} = {T}_{1} \cdot {T}_{2} \cdot {T}_{3} … {T}_{n}$$

where n represents the number of joints and/or links in the kinematic chain. The resulting matrix T_{base→bucket} represents the position of the bucket edge (e.g., the translation components in the last column of the matrix T_{base→bucket} and the orientation of the bucket edge (e.g., the rotation submatrix that includes the upper left 3×3 submatrix in the matrix T_{base→bucket}) The processing unit 110 obtains the joint angles from the data provided by the optical sensors 120, 130 or, in some embodiments, by the movement sensor 160. The link lengths and offsets are known or measured from the geometry of the asset. These values can be input or programmed into the processing unit 110.

The processing unit 110 can use this position and orientation matrix to track the position and orientation of the attachment (or the cutting edge of the attachment) in real time. The forward kinematics model can be updated by the processing unit 110 in real time as the joints move, providing the current position and orientation of the bucket edge in the coordinate frame of the asset.

For example, the asset may be a loader with an arm (referred to as link 1) and a bucket attachment (referred to as link 2), both with revolute joints. The angle of the arm relative to the chassis of the asset can be represented by the angle θ1, and the angle of the bucket relative to the arm can be represented by the angle θ2. The length of the arm can be represented by a₁, and the length from the tip of the arm (to which the bucket is attached) to the cutting edge of the bucket can be represented by a₂.

The position of the bucket edge in the asset frame is then calculated by the processing unit 110 as:

$$x = {α}_{1} cos {θ}_{1} + {α}_{2} cos ( {θ}_{1} + {θ}_{2} )$$

$$y = {α}_{1} sin {θ}_{1} + {α}_{2} sin ( {θ}_{1} + {θ}_{2} )$$

The orientation of the bucket edge is calculated by the processing unit 110 as the rotation angle θ₁+θ₂.

At 224, the position and orientation of the asset from 218 and the position and orientation of the attachment (e.g., the cutting edge of the bucket attachment) from 222 are examined to calculate the elevation of the attachment (e.g., the cutting edge of the bucket attachment).

For example, the processing unit 110 can determine the elevation of the cutting edge of the bucket by combining the position and orientation of the loader (from 218) with the position and orientation of the cutting edge of the bucket attachment (from 222). The processing unit 110 can apply geometric transformations and kinematic relationships to map the relative position of the cutting edge to the coordinate system (e.g., the global coordinate system). The position and orientation of the asset (e.g., in X, Y, and Z coordinates) can be determined using location data and movement data. The orientation of the asset (e.g., roll, pitch, and yaw) also can be provided by the movement data and the location data. The relative position of the cutting edge of the bucket with respect to the asset can be determined using data from the optical sensors and the known relative position of the reflector on the bucket to the cutting edge of the bucket. For example, the orientation of the cutting edge (e.g., tilt angle) can be calculated or derived from the geometry of the bucket. To determine the elevation of the cutting edge, the processing unit 110 can define the position and orientation of the asset in a coordinate system (e.g., a local coordinate system). The position and orientation of the cutting edge of the bucket can be calculated relative to this local coordinate system. The processing unit 110 can use the position and orientation of the asset to transform the relative position of the cutting edge to the asset into the global coordinate system.

At 226, the elevation of the terrain can be determined from the position and orientation of the terrain from 220. The processing unit 110 can determine the terrain elevation using the position and orientation of the terrain derived in 220. The processing unit 110 examines the point cloud data generated by the optical sensors 120, 130 to calculate the elevation of the terrain at specific locations.

e. Operation without Reliance on GNSS

While the location sensors may include GNSS antennas 145, 155 and receivers 140, 150, in some embodiments, the machine guidance system 100 does not include the antennas 145, 155 or receivers 140, 150, or can operate while the location sensors are inoperable or do not have access to satellite signals. For example, the machine guidance system 100 can operate indoors or in subterranean areas without having access to GNSS (e.g., GPS) signals.

In such a situation, reflectors (e.g., passive reflectors) can be placed in known locations off-board the asset. For example, the reflectors can be placed on walls or structures as reference points for positioning. The optical sensors 120, 130 and processing unit 110 can detect these off-board reflectors using point cloud data similar to how the optical sensors 120, 130 and processing unit 110 detect the reflectors onboard the asset. In another example, the optical sensors 120, 130 and processing unit 110 can detect patterns on the reflectors or positioning can be determined using SLAM algorithms. The size and/or shape of these off-board reflectors as detected by the processing unit 110 can indicate the location of the asset to the processing unit 110. For example, if square-shaped reflectors are used, the processing unit 110 can examine the point cloud data to determine whether the reflectors appear to have a square shape, a rectangular shape, a diamond shape, or the like. These different detected shapes (as well as the detected sizes) of the off-board reflectors can indicate how far (e.g., based on detected size) and the relative location of (e.g., based on the detected shape) the asset (or the optical sensor 120 and/or 130) relative to the off-board reflector. This feature allows the machine guidance system 100 to function in environments where GNSS satellite signals are unavailable, such as underground construction sites, mines, warehouses, etc.

### III. Example Asset

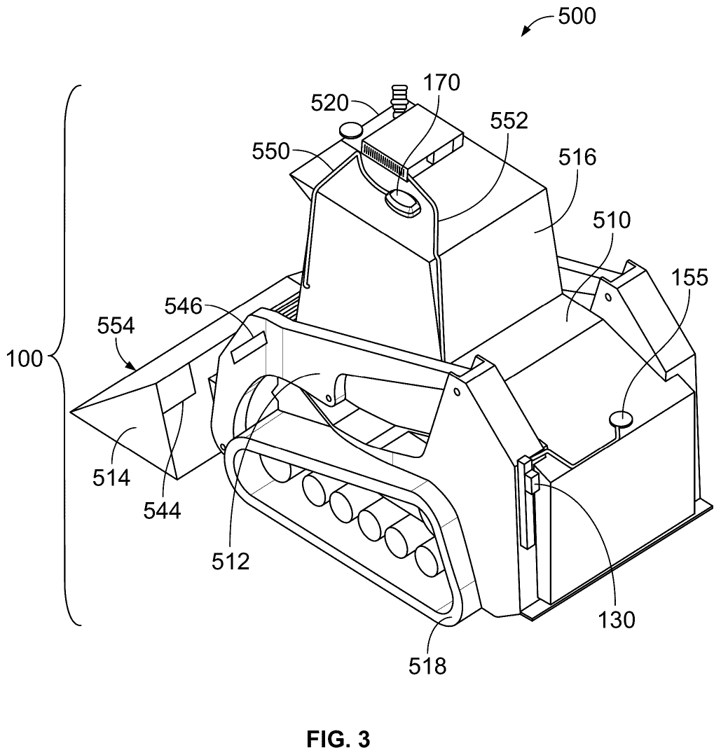

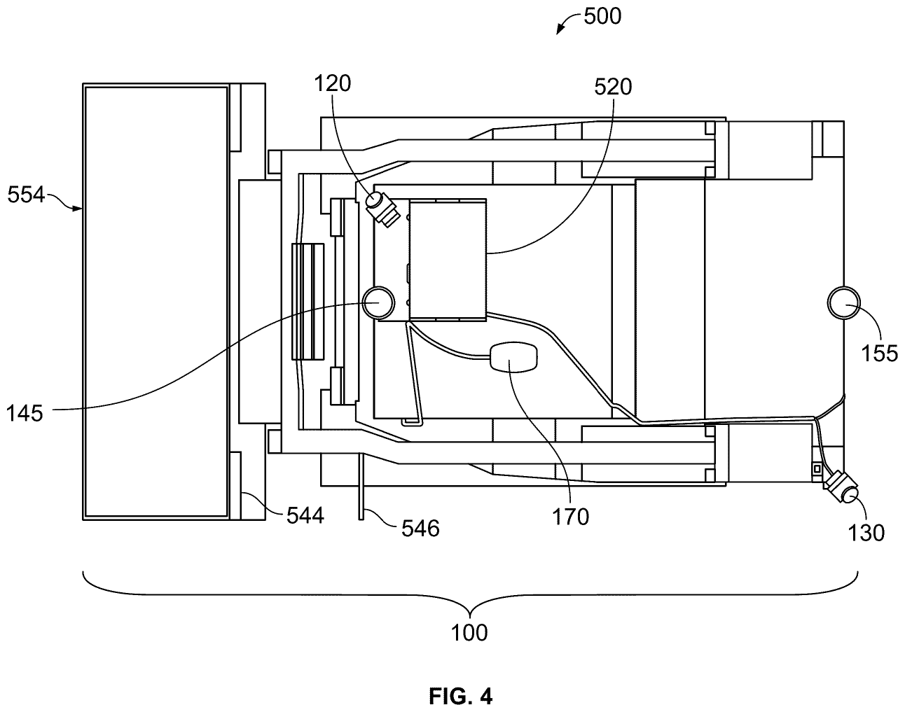

FIG. 3 is a perspective view of one example of the machine guidance system 100 shown in FIG. 1 onboard an asset 500. FIG. 4 is a top plan view of the machine guidance system 100 and the asset 500 shown in FIG. 3. The asset 500 is illustrated as a track loader that may be manually, semi-autonomously, and/or autonomously operated using the machine guidance system 100 described above. It should be understood that this example embodiment is provided to describe the various capabilities of the machine guidance system 100 and not to limit all embodiments of the inventive subject matter described herein.

The asset 500 includes a main body 510 connected to a lift arm 512, which is in turn connected to a bucket attachment 514. Other types of attachments may be attached to the lift arm 512, such as a tooth bucket, a mower, a dozer blade, a soil conditioner, a grapple, a trencher, or the like. The asset 500 also includes a cab 516 that provides an enclosure from which the operator can operate the asset 500. The asset 500 further includes a track 518 that enables movement of the asset 500 across rugged terrain. In some embodiments, the asset 500 may include wheels to move.

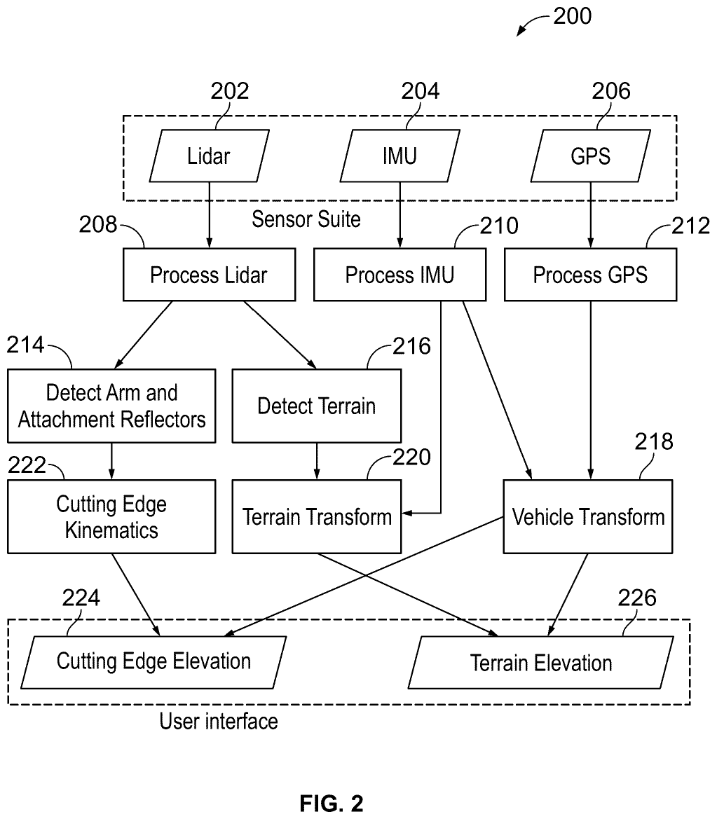

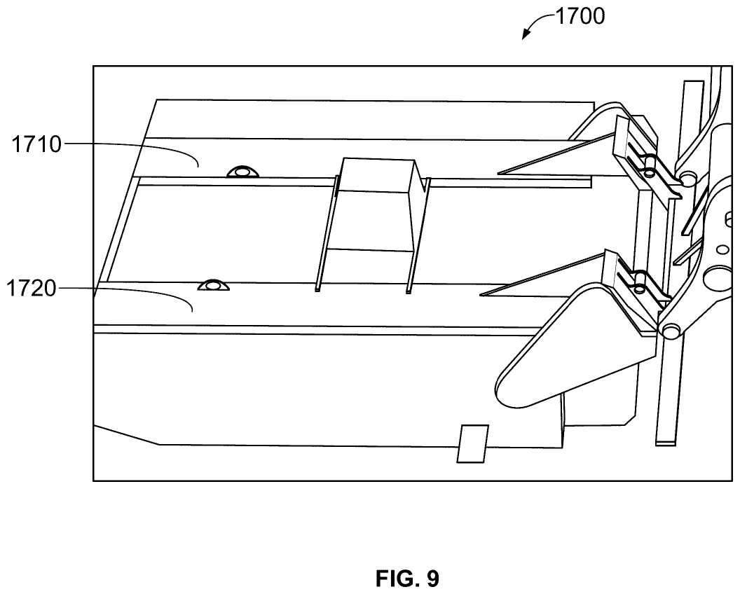

With continued reference to the asset 500 and the machine guidance system 100 shown in FIGS. 2 and 3, FIG. 4 illustrates a perspective view of a machine guidance assembly 520. The machine guidance system 100 of the asset 500 includes a machine guidance assembly 520 rigidly mounted on top of the cab 516. In some embodiments, the machine guidance assembly 520 may be mounted or located elsewhere on or in the asset 500. The machine guidance assembly 520 includes a rigid plate 522 on which is mounted a ruggedized enclosure 524 that provides isolated interfaces to the processing unit 110 and movement sensor 160, the communication network device 165, the front GNSS receiver 140, the rear GNSS receiver 150, and a power splitter 190. The cover of the ruggedized enclosure 524 is removed in FIG. 9 to show these components.

Also mounted to the rigid plate 522 is the front GNSS antenna 145 and the front optical sensor 120. In this example, the front GNSS antenna 145 is mounted on the rigid plate 522 at a location that is as far forward as possible along the x-axis of the asset 500 and generally centered along the y-axis of the asset 500. The front optical sensor 120 can be mounted on the rigid plate 522 at a location that allows the door of the cab 516, if so configured with a door, to be opened and closed, avoids contact with the arm 512 as the arm 512 is raised and lowered, and provides a line of sight to the arm/attachment joint when the arm 512 is lowered.

The asset 500 includes the rear GNSS antenna 155 mounted at the rear of the main body 510. The rear antenna 155 can be centrally located at the rear of the main body 510 to be oriented in a straight-line with the front antenna 145 along the x-axis of the asset 500. In some embodiments, the locations of the front and rear antennas 145, 155 could both be shifted along the y-axis of the asset 500 so long as the straight-line orientation between the antennas 145, 155 is maintained. In some embodiments, the location of the rear antenna 155 could be offset with respect to the front antenna 145 along the y-axis of the asset 500 as long as the location of the rear antenna 155 can be calibrated based on data from the optical sensor 120 and/or the optical sensor 130, or using manual measurements.

The machine guidance system 100 onboard the asset 500 also can include the rear optical sensor 130 mounted at or toward the rear of the main body 510. The rear optical sensor 130 can be located on the left side of the rear of the main body 510 to provide a line of sight to a first attachment reflector 544 placed on the left side of the bucket attachment 514 and a second arm reflector 546 placed on the left side of the lift arm 512 of the asset 500. The reflectors 544, 546 may be onboard the asset 500 in that the reflectors 544, 546 are mounted to the asset 500 or the attachment 514 that is coupled with the asset 500. The onboard reflectors 544, 546 may be passive reflectors as described above. The reflectors 544, 546 can be positioned to be within the field of view of the front optical sensor 120 such that one or more than one line of sight exists between the front optical sensor 120 and each of the reflectors 544, 546, or at least one of the reflectors 544, 546. In some embodiments, the front and rear optical sensors 120, 130 track movement and/or positions of the lift arm 512 and bucket attachment 514 throughout their entire range of movement, and can be positioned to provide a 360-degree field of view around the asset 500.

The asset 500 further includes the 5G/LTE/WiFi antenna 170 mounted at a fixed location on top of the cab 516. The asset 500 includes a first harness 550 that connects the machine guidance assembly 520 to the power adapter 195 and computing device located within the cab 516, as well as a second harness 552 that connects the machine guidance assembly 520 to the rear antenna 155 and rear optical sensor 130. In some embodiments, all of the components of the machine guidance assembly 520, the front antenna 145, the front optical sensor 120, the rear antenna 155, and the rear optical sensor 130 are rigidly attached to the asset 500 so that the deflections are less than 0.1 millimeters with 5G shock and vibration. Also, the asset 500 also includes the ACU 180 and various components located within the cab 516, including the input device 182, output devices 184, 186, and the power adapter 195.

### IV. Calibration and Setup

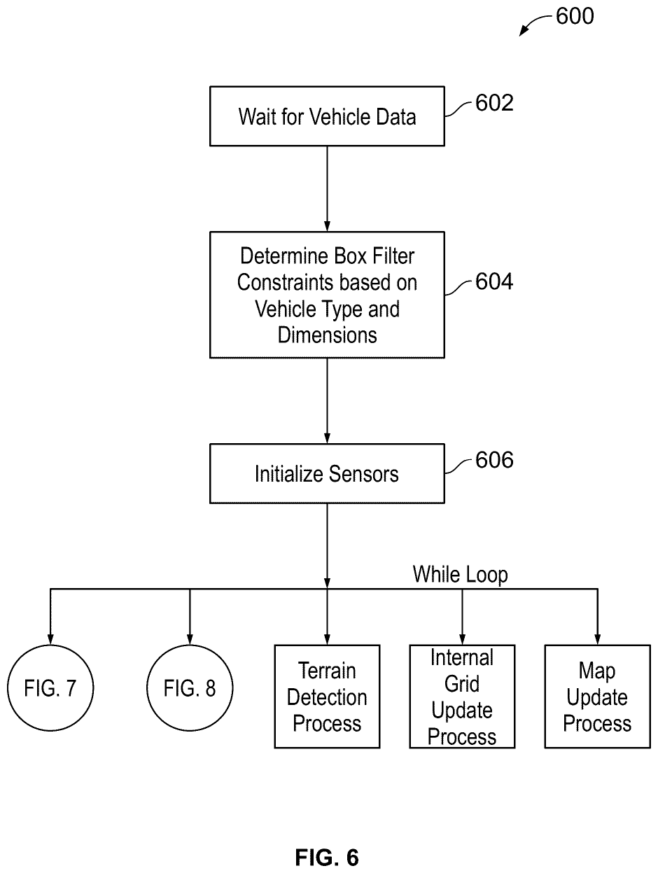

The processing unit 110 is configured to execute guidance software during operation of the asset 500. The guidance software is implemented across four processes-vision, asset observer, navigation, and map or mapping. In the vision process, the processing unit 110 analyzes data from the optical sensors 120, 130 to determine parameters for the reflectors, real-time terrain around the track loader, and any real-time obstacles near the track loader. An example vision process is described in connection with FIGS. 6 through 9. This vision process can describe at least part of the calibration and setup of the machine guidance system 100 (e.g., for an asset 500).

In the asset observer process, the processing unit 110 analyzes data from the location sensors and reflector position data (as provided or output by the vision process) to provide asset status messages that contain the real-world geographic position and orientation of the asset 500, also referred to as the state of the asset 500. In the navigation process, the processing unit 110 configures boundaries and keepouts, and organizes the boundaries and keepouts into tasks. The processing unit 110 also stores an aggregation of terrain data and progress on a task or globally at various resolutions. This data may be sent to the user interface (e.g., the onboard or in-cab computing device 175) so that the operator can see real-time terrain updates, as well as calculated cut/fill and other progress information.

In the map process, the processing unit 110 stores terrain data (as provided by the vision process) in association with cells of a map grid in an NED (North-East-Down) coordinate system. In general, an NED coordinate system is a local, Cartesian coordinate system that may be used in navigation or otherwise. In some examples, each cell includes the terrain elevation within that cell, the goal terrain elevation within that cell, information on whether an obstacle is located within that cell, and any other types of information relating to the terrain.

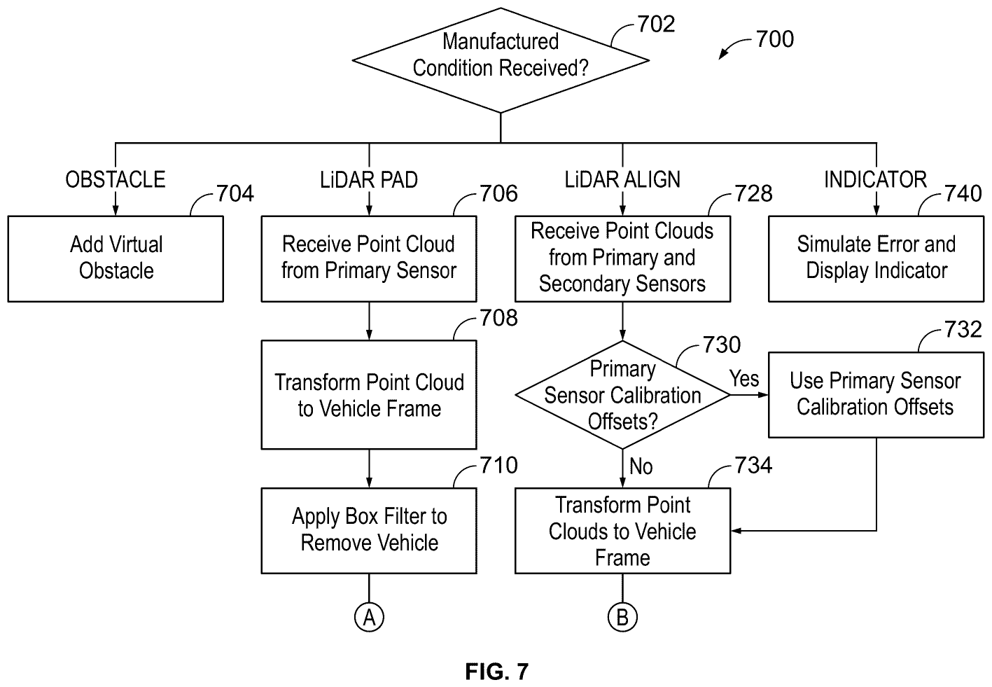

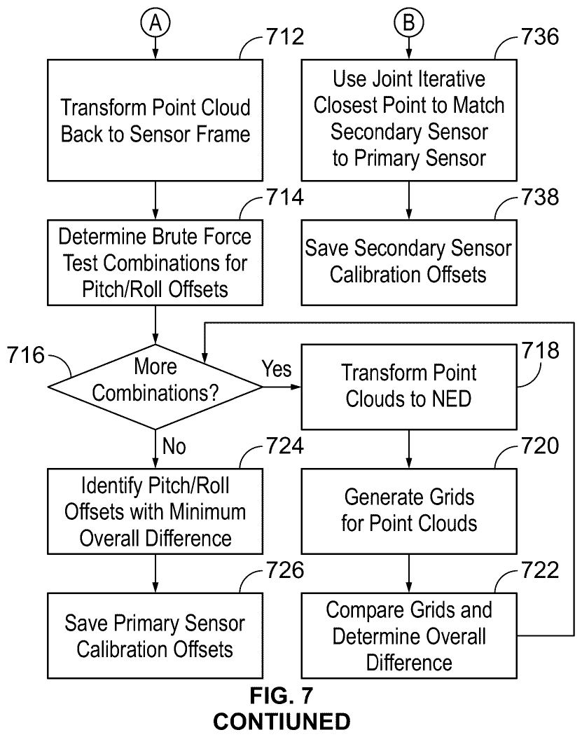

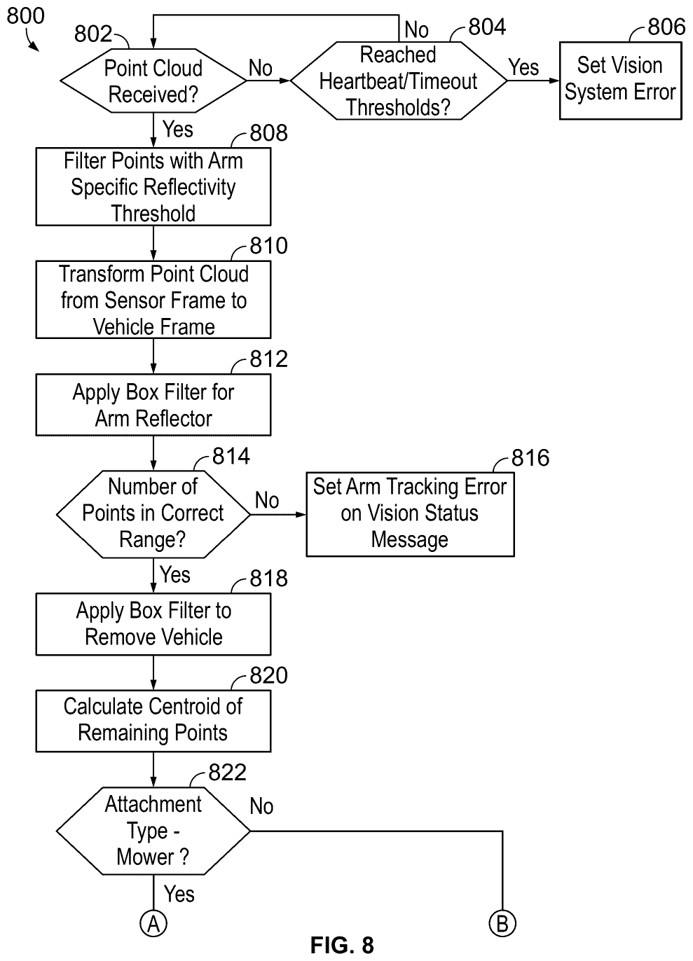

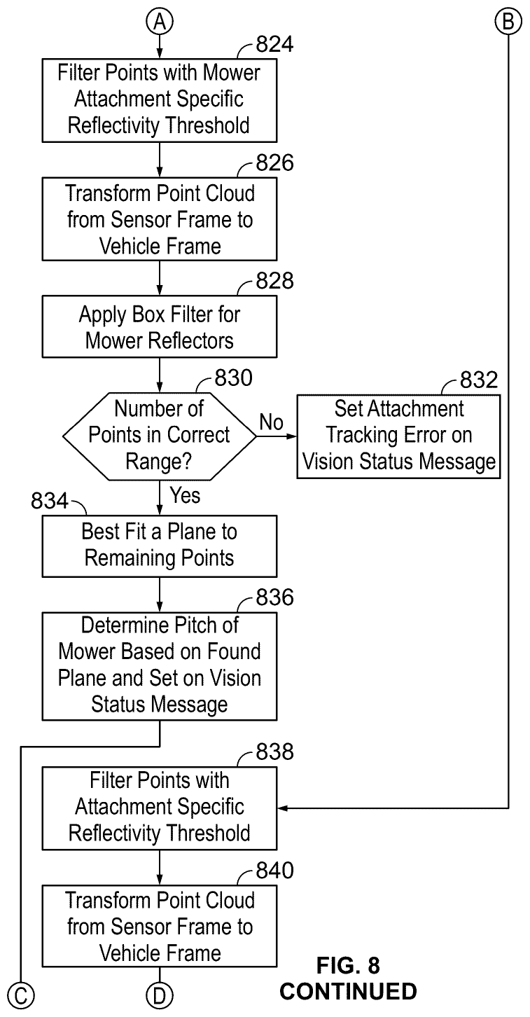

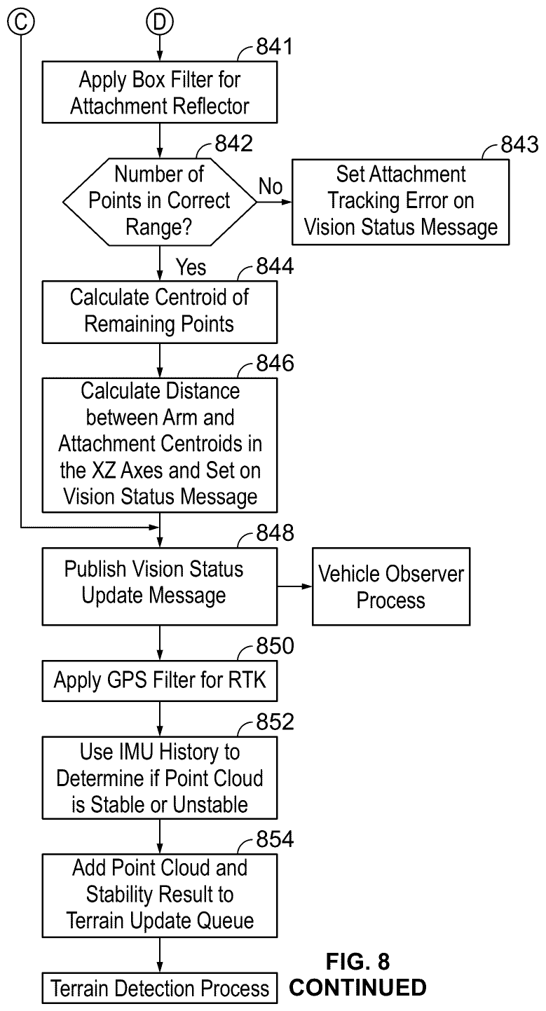

FIGS. 6 through 8 illustrate flowcharts of a vision process or method that can be used to calibrate and setup the machine guidance system 100 of the asset 500. The vision process includes an initialization process 600 (shown in FIG. 6), a while (or continuous or otherwise repeated) loop that allows the repeated execution of different processes, including a manufactured condition process 700 (shown in FIG. 7), an arm/attachment detection process 800 (shown in FIG. 8), a terrain detection process, an internal grid update process, and a map update process. The processes 700 and 800 are used for calibration or setup of the machine guidance system 100 prior to usage at a worksite, while the terrain detection process, the internal grid update process, and the map update process can be used during operation of the asset 500 and the machine guidance system 100 at the worksite and following the calibration and setup. These methods or processes can be performed by the processing unit 110 and/or other components of the machine guidance system 100, as described herein. The terrain detection process, the internal grid update process, and the map update process are described in U.S. Provisional Application No. 63/671,519 (filed 15 Jul. 2024) and U.S. patent application Ser. No. ______ (Docket Nos. EQS-003US4 and 661-0116US4).

a. Initialization Process

In the initialization process 600 as shown in FIG. 6, at 602, the initialization process 600 waits for vehicle data. This data also can be referred to as asset data. The processing unit 110 can wait until the vehicle data is provided by the sensor suite and/or by the operator. In some examples, the operator inputs the vehicle data, such as the type of asset to be operated, the attachment to be used with the asset, and one or more than one operating parameters (such as grade, vertical offset, and tolerance). The operator can use the input device 182 in the cab 516 of the asset 500 to input information such as the grade (or clear grade). The computing device 175 may be used to input the vehicle data. In some embodiments, the vehicle data may additionally or alternatively be input using the onboard computing device 175. The asset 500 is turned on or activated, and the grade is set as vehicle data. The grade can be set by automatically (under control of the processing unit 110 and/or the asset control unit 180) or manually moving the asset attachment to the desired reference elevation for the grade, and in, some embodiments, by then confirming this selection using the input device 182 and/or the onboard computing device 175. A vertical offset is input as vehicle data. The vertical offset allows adjustment of the grade that was set up or down by a specified amount (e.g., one inch).

The tolerance is set as additional vehicle data. The tolerance defines how close the attachment must be to the target grade (the grade that was set) for the machine guidance system 100 or processing unit 110 to decide that the attachment (or edge of the attachment) is “on grade.” For example, if the tolerance is set to two inches, then the cutting edge of the bucket must be within two inches of the grade that was set. Otherwise, the processing unit 110 determines that the attachment is not on grade. The processing unit 110 can then automatically implement responsive actions, such as raising the attachment, stopping movement of the asset 500, preventing further lowering of the attachment (while allowing lifting or other movement of the attachment), etc. The tolerance can be adjusted in increments, for example, by three inches, to suit the requirements of the project.

The grade and vertical offset settings can be reset if needed, which resets the machine guidance system 100 and allows the setup process to begin again. Throughout the process, the operator can use the physical buttons or switches in the cab 516 as the input device 182 to make selections and adjustments, enabling a straightforward and phone-free setup experience. In one example, the selections and adjustments may be input using the computing device 175 that is onboard or off-board the asset 500. In another example, multiple computing devices 175 may be used. One computing device 175 may be onboard and used by an operator, while another computing device 175 may be off-board the asset 500. The off-board computing device 175 may receive input (e.g., from a supervisor) to input the settings, such as the grade, offset settings, etc.

The onboard computing device 175, such as a mobile phone, can operate using a software application that presents a user interface on the onboard computing device 175. The onboard computing device 175 can communicate input received via this application to the machine guidance system 100 (e.g., using the communication device 170). For example, one or more than one machine-readable indicia (e.g., a bar code, QR code, etc.) may be printed onto a surface of the cab 516 or onto a sticker or plate that is affixed to the surface in the cab 516). The indicia can be optically scanned by the onboard computing device 175 to initiate a software application operating on the computing device 175. This application can prompt the operator of the asset to input the vehicle data described above via the onboard computing device 175. In other examples, the computing device 175 may be off-board the asset 500.

For example, the application can present a user interface workflow for setting up, operating, and troubleshooting the machine guidance system 100. The workflow can include a welcome and connection screen that identifies the type of the asset 500, followed by step-by-step prompts for the operator to select and input the type of attachment of the asset 500 (e.g., a bucket with a smooth or flat edge, or a bucket with a toothed edge), and select and input the measurement reference location (e.g., the location that the processing unit 110 controls the asset 500 to move in order to position the reference location in desired locations). For example, the onboard computing device 175 can present a graphical user interface asking the operator whether to use the outer ends of the teeth on the bucket edge as the reference point or the cutting edge of the bucket (from which the teeth project) as the reference point.

Subsequent prompts displayed on the user interface of the onboard computing device 175 direct the operator to set the grade by moving the attachment to a desired height, then input options for setting a vertical offset, if any, then options for specifying the grading tolerance, and selecting a display mode of the output devices 184, 186 (e.g., the light bars operating in standard, dual, or quad mode). Subsequent prompts or graphical user interfaces on the onboard computing device 175 can provide visual examples and demonstrations of the output device 184, 186 operating in the different modes, such as by showing how the output devices 184, 186 use colored light-emitting diodes (LEDs) to indicate whether the attachment is above, on, or below grade, as well as how the output devices 184, 186 visually convey track or asset elevation, bucket edge position, and vehicle tilt. A summary and settings screen can be displayed on the onboard computing device 175 to communicate the current asset status, grade settings, attachment type, and mode of the output devices 184, 186.

The onboard computing device 175 can present several troubleshooting and error handling screens or graphical user interfaces that list detected issues such as missing reflectors 544, 546, obstructions of the antennas 145, 155, connection problems for the sensors 120, 130, 160 and/or receivers 140, 150, undetected attachments, etc. For each issue, the interface provided on the onboard computing device 175 provides step-by-step instructions and annotated photos to help the operator resolve the problem, including checking hardware connections, cleaning sensors 120, 130, 160, and ensuring clear lines of sight for the antennas 145, 155. The workflow that is presented on the onboard computing device 175 is intuitive, thereby guiding the operator through setup, operation, and troubleshooting with clear visual and/or textual feedback at each stage.

At 604 in the method 600 shown in FIG. 6, box filter constraints are determined based on the asset type and dimensions of the asset. These box filter constraints define the one or more than one box filters that are used for processing the point cloud data from the optical sensors 120, 130, as described above. Different box filter constraints can be calculated. For example, the box filter constraints can define different box filters, including a box filter for the asset 500, another box filter for the arm reflector 546, another box filter for the attachment reflector 544, and the like. At 606, the sensors in the sensor suite are initialized based on the configuration of the asset 500. For example, certain operating parameters for the front optical sensor 120 and the rear optical sensor 130 are initialized, such as the horizontal field-of-view resolution, update rate, etc.

Following 606, the method 600 proceeds through one or more than one of the method 700 (as further described in FIG. 7), the method 800 (as further described in FIG. 8), the terrain detection process, the internal grid update process, or the map update process. These methods 700, 800, the terrain detection process, the internal grid update process, and/or the map update process can be performed sequentially or in series, in parallel, or a combination thereof.

b. Manufactured Condition Process

FIG. 7 illustrates a flowchart of one example of the manufactured condition process or method 700. The method 700 may per performed during the initialization process 600 (see FIG. 6) by the machine guidance system 100 (see FIG. 1), or otherwise performed. At 702, a decision is made as to whether a manufactured condition message type has been received. A manufactured condition message type refers to a message or status notification generated by the machine guidance system 100 to indicate a predefined or expected operational state, configuration, or diagnostic result of the machine guidance system 100 or the components of the machine guidance system 100 and/or asset 500. These messages can communicate that the machine guidance system 100, sensor 120, 130, 160, the receivers 140, 150, attachment, or the like, is in a particular condition as intended by the manufacturer or as required for proper operation. If a manufactured condition message is received, then flow of the method 700 can proceed along one or more than one sub-processes or methods of the method 700, such as an obstacle sub-process (e.g., at 704), a first optical sensor sub-process (also referred to as a LiDAR pad sub-process and described in connection with 706, 708, 710, 712, 714, 716, 724, 726), a second optical sensor sub-process (also referred to as a LiDAR align sub-process and described in connection with 718, 720, 722, 728, 730, 734, 736, 738), or an indicator sub-process (e.g., at 730 and 732). Each of these sub-processes can represent the operations performed by the processing unit 110. If no manufactured condition message is received, then flow of the method 700 may terminate and return to another process 800, the terrain detection process, the internal grid update process, or the map update process, or operation in the method 600.

As described above, if a manufactured condition message is received, then flow of the method 700 can proceed from 702 toward 704 to the obstacle sub-process or to one or more than one of the first optical sensor sub-process, the second optical sensor sub-process, and/or the indicator sub-process. At 704, the obstacle sub-process adds a virtual obstacle corresponding to an obstacle located in the real-world at the worksite. A user interface (e.g., on the onboard computing device 175) is displayed that receives input to define the location of the virtual obstacle. The map sub-process uses this information to store the virtual obstacle in association with the applicable cells of the map grid. The operator may set a time at which the virtual obstacle is to be removed from the cells of the map grid. The virtual obstacle can be created to provide a defined location (e.g., geographic coordinate), defined area (e.g., two dimensional area), or volume (e.g., three dimensional space).

The first optical sensor sub-process can be used to calibrate the front optical sensor 120 (which is the primary sensor in this example) when the asset 500 is in a designated state (e.g., in a stationary position on a known flat pad or surface). At 706, point cloud data is received from the front optical sensor 120 and, at 708, the point cloud data is transformed from the sensor coordinate frame to the asset coordinate frame of the asset 500. At 710, at least one of the box filters for the asset 500 is applied to the point cloud data from the front optical sensor 120 to remove data points associated with the asset 500. At 712, the filtered point cloud data from the front optical sensor 120 that was transformed from the vehicle coordinate frame of the asset 500 is transformed back to the sensor coordinate frame. This can ensure that the data points are effectively used to identify the asset 500 and then returned to the format or coordinate frame useful for one or more other processes performed by the processing unit 110.

At 714, a brute force process is initiated to determine pitch and roll calibration offsets for the front optical sensor 120. These calibration offsets may be used to align the front optical sensor 120 with the front locator antenna 140 (which can serve as a reference point for the system 100 in this example). To perform this process, the processing unit 110 can determine the numerical values of desired test combinations of candidate pitch and roll offset values for the asset 500. In some embodiments, the test combinations are numerical values that are −2.0 degrees to 2.0 degrees from original estimates for the pitch and roll offsets with a resolution of 0.01 degrees. In some embodiments, another upper or lower bound to this range may be used, and/or the resolution may be larger or smaller, as needed for the project being performed by the asset 500. The processing unit 110 may select random, quasi-random, or predetermined values for the pitch and roll offset values to be tested or examined.

At 716, the pitch and roll offsets for the first test combination are identified and used to make minor adjustments to the orientation of the filtered point cloud data. The processing unit 110 can adjust the orientation of the filtered point cloud data so that the cloud data accurately represents the real-world terrain and objects relative to a consistent reference frame such as of the asset, the front optical sensor 120, or another coordinate frame. The processing unit 110 can apply these offsets due to the front optical sensor 120 not always being perfectly level or aligned with a reference frame due to uneven terrain, slopes, mounting imperfections, etc. If the pitch and roll of the front optical sensor 120 are not accounted for, the point cloud data may be skewed, and the calculated elevations and positions of terrain features and obstacles may be inaccurate. The processing unit 110 calculates a rotation (or transformation) matrix that describes how to rotate the point cloud data to correct for the orientation of the front optical sensor 120. The points in the filtered point cloud are mathematically rotated using this matrix so that features in the data correspond to the true positions and elevations in the reference frame.

At 718, the adjusted point cloud data is transformed from the sensor coordinate frame to the NED coordinate frame. At 720, the transformed point cloud data is used to generate a grid and, at 722, the grid is compared to the flat pad or surface on which the asset 500 is located to determine the overall difference (or error) between the grid and the flat pad or surface. If the grid is not parallel to or is otherwise misaligned to the flat pad or surface (e.g., a reference surface), then there is a calibration error for that grid. For example, if the grid of cloud data points are slightly angled by two degrees to the reference surface, then there is a calibration error representative of two degrees. This calibration error is identified or calculated by the processing unit 110 and associated with (e.g., stored with) the offset values used to generate that grid.

The operations of 716-722 can be repeated for each test combination (e.g., for each pair or several pairs of the pitch and roll offset values). At 724, the test combination with the pitch and roll offsets that result in the minimum overall difference (or the lowest calibration error) are identified. The processing unit 110 can calculate this difference as the smallest difference between the grid and the pad or surface. At 726, those pitch and roll calibration offsets are saved for use as the calibration offsets for the front optical sensor 120. For example, the calibration offset values for the front optical sensor 120 can be applied to the point cloud data that is output by the front optical sensor 120 during operation of the asset 500. This calibration process and adjustment can be repeated, such as periodically, on demand, each day, or the like. The adjusted point cloud data can help the asset 500 safely and autonomously move while avoiding collisions with obstacles and/or while autonomously performing work (e.g., grading a worksite). The processing unit 110 can use this data to generate alerts to warn operators of proximities of the asset 500 to obstacles through the output devices 184, 186 and/or the computing device 175.

The second optical sensor alignment process can be used to calibrate the rear optical sensor 130 (which is the secondary sensor in this example) to be aligned with the front optical sensor 120. This alignment may result in the orientations of the point cloud data obtained by each optical sensor 120, 130 being aligned with each other, without having to physically or mechanically change the orientation or location of either optical sensor 120, 130.

At 728, point cloud data is received from the front optical sensor 120 and the rear optical sensor 130. At 730, a decision is made whether there are calibration offsets for the front optical sensor 120 (such as the calibration offsets determined using the first optical sensor pad process). If the processing unit 110 decides that there were offsets identified at 726, at 732, the calibration offsets are used to adjust the point cloud data received from the front optical sensor 120 and the process proceeds toward 734. If there are no calibration offsets for the front optical sensor 120, the process proceeds toward 734.

At 734, the point clouds received from the front optical sensor 120 (whether adjusted or not) and the rear optical sensor 130 are transformed from the sensor coordinate frame to the vehicle coordinate frame of the asset 500. At 736, a joint iterative closest point (ICP) algorithm is used to minimize the difference between the two point clouds and calculate the pitch, roll, yaw, and position (x, y, z) calibration offsets for the rear optical sensor 130. At 738, those calibration offsets are saved for use as the calibration offsets for the rear optical sensor 130. For example, the calibration offset values for the rear optical sensor 130 can be applied to the point cloud data that is output by the rear optical sensor 130 during operation of the asset 500. This calibration process and adjustment can be repeated, such as periodically, on demand, each day, or the like. The adjusted point cloud data can help the asset 500 safely and autonomously move while avoiding collisions with obstacles and/or while autonomously performing work (e.g., grading a worksite).

The indicator process is used by the processor unit 110 to simulate a sensor failure or logic error to determine whether the appropriate indicator (such as a light or symbol generated by an output device) is displayed to the operator. At 740, a particular sensor failure or logic error is simulated, and the appropriate message is reported to the user interface to thereby test the indicator. For example, the processing unit 110 can intentionally generate a condition that mimics an actual fault. The faults that may be mimicked can be, for example, a disconnected sensor 120, 130, 160, a disconnected receiver 140, 150, a blocked antenna 145, 155, a missing reflector 544, 546, a software logic error that would affect data processing or attachment detection, etc. The processing unit 110 can simulate such a fault by generating or blocking communication of signals to and/or from various components of the machine guidance system 100. When such a simulated failure or error is triggered, the system 100 processes the failure of error as if the fault or error were an actual event occurring during normal operation. Upon detecting the simulated fault, the processing unit 110 can generate a corresponding error or warning message and sends the message to the onboard computing device 175, which may include a display screen, LED light bar, or audio alert. The onboard computing device 175 can present the appropriate visual or audio indicator (e.g., a warning icon, a specific error message, or a change in light bar color or pattern) so that the operator is informed of the fault or error being mimicked. In the event of a real sensor malfunction or software issue during field operation, the processing unit 110 and system 100 is able to reliably operate to notify the operator.

c. Arm and/or Attachment Detection Process

FIG. 8 illustrates a flowchart of one example of an arm/attachment detection process or method 800. The method 800 can analyze the point cloud data received from the front and rear optical sensors 120, 130 to track the lift arm 512 and attachment 514 of the asset 500. This tracking is performed based on the positions and orientations of the arm reflector 546 and attachment reflector 544. This process 800 also allows for the tracking of other types of attachments, such as a mower attachment, as described below. In some examples, the point cloud data received from the front and rear optical sensors 120, 130 are fused with each other to enable the analysis of a single point cloud by the processing unit 110. In some embodiments, the point cloud data received from the different sensors 120, 130 remain separate for analysis by the processing unit 110.

At 802, a decision is made whether point cloud data has been received (e.g., by the processing unit 110) while the arm of the asset 500 is within the field of view of the front optical sensor 120 and/or the rear optical sensor 130. If not, at 804, a decision is made whether a heartbeat threshold and/or timeout threshold has been reached. The heartbeat threshold can be in the range of 1 to 10 missed messages (e.g., the number of regularly repeated messages that the optical sensors 120, 130 are to output point cloud data with the messages being missed or not received) and the timeout threshold can be in the range of 100 milliseconds to 1,000 milliseconds (e.g., the delay between consecutive messages from the optical sensor 120 and/or 130). In some embodiments, other ranges may be used. If the applicable threshold(s) has or have been reached, the method 800 sets a vision system error at 806. These operations can involve the processing unit 110 directing an output device, computing device 175, or display to notify the operator of the sensor error. If not, the process 800 returns to 802.

If point cloud data has been received, the process 800 proceeds to 808. At 808, data points having reflectivity or signal values below a predetermined threshold specific to the lift arm 512 are filtered out to remove data points attributable to dust, debris, dirty reflectors 544, 546, etc. At 810, the filtered point cloud data is transformed from the sensor coordinate frame to the vehicle coordinate frame of the asset 500, as described above. At 812, a box filter for the arm reflector 546 is applied to the point cloud data to remove data points that are not associated with the arm reflector 546.

At 814, a decision is made whether the total number of filtered data points is within a predetermined range that includes the expected number of data points to be associated with the arm reflector 546. The expected number of data points may be set by repeatedly measuring the number of data points collected from reflection of the light emitted by the sensor 120 or 130, reflected off the reflector, and detected by the sensor 120 or 130. A lower, or the lowest, number of detected data points may be identified from these repeated measurements and a larger, or the largest, number of detected data points may be identified from these repeated measurements. A percentage of the range of data points from the lower, or the lowest, number and the larger, or largest, number may be selected as the expected number of data points. For example, if the lower or lowest number is zero and the larger or largest number is 100, then a range of ten percent, twenty percent, thirty percent, or the like, of this range may be used as the predetermined range. As one example, the predetermined range may be ten to thirty data points (e.g., ten to thirty percent of the range).

If the number of data points is not within the predetermined range of this expected number, the process 800 sets an arm tracking error on the vision status message at 816. The processing unit 110 can direct an output device to notify the operator of this error. There can be different causes for such an error, such as an object blocking the view between an optical sensor 120, 130 and the arm reflector 546, the arm reflector 546 falling off the asset 500, damage to the arm reflector 546, a dirty optical sensor 120, 130, too much dust in the environment, a foreign reflective object close to the arm reflector 546 (e.g., within the field of view of the sensor 120 or the sensor 130), or the like. Of course, other causes for error will be apparent to one of ordinary skill in the art. If the total number of data points is within the predetermined range, at 818, a box filter for the asset 500 is applied to the point cloud data to remove all data points associated with the asset 500. At 820, the (x, y, z) values of the centroid of the filtered data points are calculated. For example, the processing unit 110 can calculate the average of the coordinates of the points in the filtered point cloud data.

At 822, a decision is made whether the attachment type is a mower (such as a brush hog mower attachment). A mower attachment may be processed differently than other attachments because the mower attachment is more likely to be used in high brush (for example, brush that is five feet tall or more) and contain sticks, branches, brush, or other debris falling on the attachment.

With continued reference to the process 800 shown in FIG. 8, FIG. 9 shows an example mower attachment 1700 with two attachment reflectors 1710, 1720 placed thereon. To accommodate these environmental conditions, at least two additional reflectors 1710, 1720 that are relatively large in scale (e.g., larger than the reflectors 544, 546) are placed on the top surface of the mower attachment 1700 (or in another location that is within a field of view of the front optical sensor 120 and/or the rear optical sensor 130.

If the attachment type is a mower, at 824, data points having reflectivity or signal values below a predetermined threshold specific to the mower attachment 1700 are filtered out to remove data points attributable to dust and various types of debris. For example, the reflectivity values of the data points may vary between a lower or minimum value and an upper or maximum value. The predetermined threshold used to filter out data points having lower reflectivity values may be 50% of the upper or maximum value, 60% of the upper or maximum value, or another percentage. This allows the method 800 to maintain accurate and consistent performance even in harsh or dusty environments commonly encountered on construction sites. The filtering process reduces noise in the data, improving the overall reliability and precision of the method 800. While the mower attachment 1700 is used in this example, other attachments may be used with additional reflectors 1710, 1720 attached, and the cloud data points associated with the attachment may be filtered in a similar way.

At 826, the point cloud data is transformed from the sensor coordinate frame to the vehicle coordinate frame of the asset 500. At 828, a box filter for the reflectors on the attachment is applied to the point cloud data to remove data points that are not associated with these reflectors. At 830, a decision is made whether the total number of filtered data points is within a predetermined range that includes a predetermined number of expected data points associated with the attachment reflectors 1710, 1720. If the number of data points is not within the predetermined range, the process 800 sets an attachment tracking error on the vision status message at 832. As described above, the processing unit 110 can communicate this error to the operator using output devices. There can be different causes for such an error, such as an object blocking the view between an optical sensor 120, 130 and the attachment reflectors 1710, 1720, at least one of the attachment reflectors 1710, 1720 falling off the asset 500, damage to the attachment reflectors 1710, 1720, a dirty front optical sensor 120 or rear optical sensor 130, too much dust or debris in the environment, or a foreign reflective object close to the attachment reflectors 1710, 1720 (e.g., within the field of view of a sensor 120 and/or 130). Of course, other causes for error will be apparent to one of ordinary skill in the art. If the total number of data points is within the predetermined range, the process 800 proceeds toward 834.

If there is debris covering part of the attachment 1700, the overall shape and orientation of the attachment reflectors 1710, 1720 can still be determined by the processing unit 110. At 834, the plane of best fit to the filtered data points is found. The processing unit 110 can find this plane of best using least squares fitting. The processing unit 110 calculates the plane that minimizes or otherwise reduces a sum of the squared distances from all the filtered data points to the plane.

At 836, the plane that is found at 834 is used to determine the pitch of the attachment 1700, and that pitch is set on the vision status message. For example, the processing unit 110 can output this message to indicate the set pitch to the operator via the onboard computing device 175. At 848, the vision status message can be published for use by a vehicle observer process (described in U.S. Provisional Application No. 63/671,519 (filed 15 Jul. 2024) and U.S. patent application Ser. No. ______ (Docket Nos. EQS-003US4 and 661-0103US4)).

The vehicle observer process is a software routine within the machine guidance system 100 (e.g., that directs the processing unit 110) to determine and track the real-world position and orientation (e.g., pose) of the asset 500 and its attachments in real time. The process involves the processing unit 110 receiving and analyzing data from the sensors 120, 130, 160, the receivers 140, 150, and/or reflector and terrain information. The processing unit 110 fuses and uses the fused sensor data to calculate parameters like the geographic location of the asset 500, the heading of the asset 500, the pitch of the asset 500, and the position and orientation of the attachment (e.g., the cutting edge of a bucket). The vehicle observer process publishes this information as a status message, which is used by other components of the system 100 for guidance, control, and display to the operator, ensuring accurate and up-to-date awareness of the machine's state and configuration during operation.

If the attachment type is determined to not be the mower attachment 1700 at 822 (e.g., the attachment is the bucket attachment 514), the process 800 proceeds toward 838. At 838, data points having reflectivity or signal values below a predetermined threshold specific to the other attachment (e.g., the bucket attachment 514) are filtered out to remove data points attributable to dust, etc. For example, the reflectivity values of the data points may vary between a lower or minimum value and an upper or maximum value. The predetermined threshold used to filter out data points having lower reflectivity values may be 50% of the upper or maximum value, 60% of the upper or maximum value, or another percentage. At 840, the point cloud data is transformed from the sensor coordinate frame to the vehicle coordinate frame of the asset 500. At 841, a box filter for the reflector 544 on the bucket attachment 514 is applied to the point cloud data to remove data points that are not associated with the attachment reflector 544.

At 842, a decision is made whether the total number of filtered data points is within a predetermined range that includes the expected number of data points to be associated with the attachment reflector 544. As described above, the expected number of data points can be determined by repeatedly measuring the number of data points that are detected and setting an expected range as a range of percentages of the number of data points between the lower or lowest number and the larger or largest number. If the number of data points is not within the predetermined range, the processing unit 110 can generate or set an attachment tracking error on the vision status message at 843. There can be different causes for such an error, such as an object blocking the view between an optical sensor 120, 130 and the attachment reflector 544, the attachment reflector 544 falling off the asset 500, damage to the attachment reflector 544, a dirty optical sensor(s) 120 and/or 130, too much dust or debris in the environment, or a foreign reflective object close to the attachment reflector 544 (e.g., within the field of view of the front optional sensor 120 and/or the rear optical sensor 130). Of course, other causes for error will be apparent to one of ordinary skill in the art. If the total number of data points is within the predetermined range, the process 800 proceeds toward 844.

At 844, the (x, y, z) values of the centroid of the filtered data points are calculated. At 846, the distance between the attachment centroid (from 844) and the arm centroid (from 820) in the XZ plane, and that distance along with the (x, y, z) values of the attachment and arm centroids are set on the vision status message. For example, the processing unit 110 can direct an output device to present this information to the operator. The process 800 proceeds toward 848 so that the vision status message can be published for use by the vehicle observer process.

At 850, the process 800 confirms that the GNSS receivers 140, 150 have determined the positions of the GNSS antennas 145, 155, respectively. Confirming these positions may be performed using RTK positioning technology. At 852, the movement sensor history from the movement sensor 160 is used to determine whether the point cloud data is stable or unstable. The movement sensor history can be movements previously sensed by the movement sensor 160. For example, the processing unit 110 can decide that the point cloud data is stable if the asset 500 is driven slowly around a worksite (e.g., slower than a threshold speed, such as five miles per hour). In contrast, the processing unit 110 can decide that the point cloud data is unstable if the asset 500 is driven rapidly around a worksite (e.g., at least as fast as the threshold speed) to cause excessive bouncing, in which case the accuracy of the data may be degraded. In some examples, the point cloud data received over a predetermined window (such as one to ten seconds) is analyzed by the processing unit 110 to calculate the standard deviation of the data points. If the standard deviation is at or below a predetermined threshold, the point cloud data is determined to be stable. However, if the standard deviation is above the predetermined threshold, the point cloud data is determined to be unstable. At 854, the point cloud data and stability result are added to the terrain update queue and processed using the terrain detection process.

The calibration and setup of the machine guidance system 100 for use with the asset 500 and the attachment can be validated. In one example, a validation kit comprising one or more sensors, such as one or more GNSS antennas 145, 155 and GNSS receivers 140, 150 may be used to validate the calibration and setup of the machine guidance system. The GNSS antennas 145, 155 can be positioned on the attachment, such as the cutting edge of the attachment. Location and/or orientation information about the attachment can be obtained from the additional GNSS receivers using satellite signals received by these additional GNSS antennas. This information is compared with the location and/or orientation information determined by the machine guidance system 100. If the location and/or orientation determined by the validation kit does not match or is not within a tolerance threshold of the location and/or orientation determined by the machine guidance system 100, then the processing unit 110 determines that the calibration and setup of the machine guidance system 100 is incorrect. One or more of the calibration and setup processes or methods described herein may then be repeated. Otherwise, the processing unit 110 determines that the calibration and setup of the machine guidance system 100 was successful, and autonomous or partially autonomous operation of the asset 500 can begin or continue.

One or more examples of the processes and methods described herein include a computer-implemented method that can include receiving point cloud data from an optical sensor of a machine guidance system onboard an asset. The point cloud data can represent a sensed environment that includes a portion of the asset and surrounding terrain. The method also can include transforming the point cloud data from a sensor coordinate frame to an asset coordinate frame, applying different candidate pitch and roll offset values to the point cloud data, generating a grid representation of the sensed environment for each of plural combinations of the candidate pitch and roll offset values, calculating a calibration error for each of the combinations of the candidate pitch and roll offset values by comparing each of the grid representations to a reference surface, and selecting a particular combination from the combinations exhibiting a smaller value of the calibration errors and applying the pitch and roll calibration values associated with the smaller value of the calibration errors to the point cloud data output by the optical sensor during subsequent operation of the asset.

The method also can include receiving additional point cloud data from the optical sensor while the asset is at least partially autonomously performing material handling or earthmoving, modifying the additional point cloud data using the pitch and roll calibration values that are selected, and changing movement of the asset or an attachment of the asset using the additional point cloud data that is modified to one or more of autonomously avoid colliding with an obstacle or autonomously grade a worksite. The optical sensor can be a first optical sensor, the point cloud data can be first point cloud data, and the method also can include receiving second point cloud data from a second optical sensor onboard the asset, transforming the second point cloud data to the asset coordinate frame, and calculating pitch, roll, yaw, and position calibration offset values for the second point cloud data by comparing the first point cloud data and the second point cloud data.

The method also can include receiving additional first point cloud data from the first optical sensor and additional second point cloud data from the second optical sensor while the asset is at least partially autonomously performing material handling or earthmoving, modifying the additional first point cloud data using the pitch and roll calibration values that are selected, modifying the additional second point cloud data using the pitch, roll, yaw, and position calibration offset values that are calculated, and changing movement of the asset or an attachment of the asset using the additional first point cloud data that is modified and the additional second point cloud data to one or more of autonomously avoid colliding with an obstacle or autonomously grade a worksite.

The method also can include receiving, via an input device, vehicle data that specifies operating parameters for the asset, the operating parameters including one or more of a target grade, a vertical offset of the target grade, or a tolerance for the target grade. The operating parameters, the combination that is selected, and additional point cloud data from the optical sensor can be used to autonomously control the asset during a grading operation.

The method also can include applying one or more box filter constraints to the point cloud data output by the optical sensor, the one or more box filter constraints based on predetermined dimensions of the asset. Applying the one or more box filter constraints can include removing data points within the point cloud data having a signal value below a predetermined threshold.

The method also can include obtaining additional point cloud data from the optical sensor while an arm of the asset is within a field of view of the optical sensor, filtering out first data points having reflectivity or signal values below a predetermined threshold associated with an arm of the asset from the additional point cloud data, and applying a box filter associated with the arm to the additional point cloud data with the first data points removed, the box filter applied to eliminate second data points from the additional point cloud data that are not associated with the arm.

The method also can include obtaining additional point cloud data from the optical sensor while an attachment is joined to an arm of the asset and the attachment is within a field of view of the optical sensor, filtering out first data points having reflectivity or signal values below a predetermined threshold associated with the attachment from the additional point cloud data, and applying a box filter associated with the attachment to the additional point cloud data with the first data points removed. The box filter can be applied to eliminate second data points from the additional point cloud data that are not associated with the attachment.

One or more examples of the machine guidance systems described herein include a machine guidance system that includes an optical sensor configured to be onboard the asset and to output point cloud data representative of a sensed environment that includes a portion of the asset and surrounding terrain, and a processing unit configured to receive the point cloud data and transform the point cloud data from a sensor coordinate frame to an asset coordinate frame. The processing unit can apply different candidate pitch and roll offset values to the point cloud data, generate a grid representation of the sensed environment for each of plural combinations of the candidate pitch and roll offset values, and calculate a calibration error for each of the combinations of the candidate pitch and roll offset values by comparing each of the grid representations to a reference surface. The processing unit can select the combination exhibiting a smaller value of the calibration errors and apply the pitch and roll calibration values associated with the smaller value of the calibration errors to the point cloud data output by the optical sensor during subsequent operation of the asset.

The optical sensor can output additional point cloud data while the asset is at least partially autonomously performing material handling or earthmoving. The processing unit can modify the additional point cloud data using the pitch and roll calibration values that are selected and to change movement of the asset or an attachment of the asset using the additional point cloud data that is modified to one or more of autonomously avoid colliding with an obstacle or autonomously grade a worksite. The optical sensor can be a first optical sensor, the point cloud data can be first point cloud data, and the machine guidance system also can include a second optical sensor configured to be onboard the asset and to output second point cloud data. The processing unit can transform the second point cloud data to the asset coordinate frame and to calculate pitch, roll, yaw, and position calibration offset values for the second point cloud data by comparing the first point cloud data and the second point cloud data.

The first optical sensor can output additional first point cloud data and the second optical sensor can output additional second point cloud data while the asset is at least partially autonomously performing material handling or earthmoving. The processing unit can modify the additional first point cloud data using the pitch and roll calibration values that are selected and to modify the additional second point cloud data using the pitch, roll, yaw, and position calibration offset values that are calculated. The processing unit can change movement of the asset or an attachment of the asset using the additional first point cloud data that is modified and the additional second point cloud data to one or more of autonomously avoid colliding with an obstacle or autonomously grade a worksite.

The machine guidance system also can include an input device configured to receive vehicle data that specifies operating parameters for the asset. The operating parameters can include one or more of a target grade, a vertical offset of the target grade, or a tolerance for the target grade. The processing unit can autonomously control the asset during a grading operation using the operating parameters, the combination that is selected, and additional point cloud data from the optical sensor.

The processing unit can apply one or more box filter constraints to the point cloud data output by the optical sensor. The one or more box filter constraints can be based on predetermined dimensions of the asset. The processing unit can apply the one or more box filter constraints by removing data points within the point cloud data having a signal value below a predetermined threshold.

The processing unit can obtain additional point cloud data from the optical sensor while an arm of the asset is within a field of view of the optical sensor. The processing unit can filter out first data points having reflectivity or signal values below a predetermined threshold associated with an arm of the asset from the additional point cloud data and apply a box filter associated with the arm to the additional point cloud data with the first data points removed. The box filter can be applied to eliminate second data points from the additional point cloud data that are not associated with the arm.

The processing unit can obtain additional point cloud data from the optical sensor while an attachment is joined to an arm of the asset and the attachment is within a field of view of the optical sensor. The processing unit can filter out first data points having reflectivity or signal values below a predetermined threshold associated with the attachment from the additional point cloud data. The processing unit can apply a box filter associated with the attachment to the additional point cloud data with the first data points removed. The box filter can be applied to eliminate second data points from the additional point cloud data that are not associated with the attachment.

One or more examples of the methods and processes described herein also include a computer-implemented method that includes receiving first point cloud data from a first LiDAR sensor onboard the asset and second point cloud data from a second LiDAR sensor onboard the asset. The first point cloud data and the second point cloud data can represent a sensed environment that includes a portion of the asset and surrounding terrain. The method also can include transforming the first point cloud data and the second point cloud data from a sensor coordinate frame to an asset coordinate frame, applying different candidate pitch and roll offset values to the first point cloud data, generating a grid representation of the sensed environment for each of plural combinations of the candidate pitch and roll offset values, calculating a calibration error for each of the combinations of the candidate pitch and roll offset values by comparing each of the grid representations to a reference surface, selecting the combination exhibiting a smaller value of the calibration errors and applying the pitch and roll calibration values associated with the smaller value of the calibration errors to the first point cloud data output by the first LiDAR sensor during subsequent operation of the asset, calculating pitch, roll, yaw, and position calibration offset values for the second point cloud data by comparing the first point cloud data and the second point cloud data, receiving additional first point cloud data from the first LiDAR sensor and additional second point cloud data from the second LiDAR sensor while the asset is at least partially autonomously performing material handling or earthmoving, modifying the additional first point cloud data using the pitch and roll calibration values that are selected, modifying the additional second point cloud data using the pitch, roll, yaw, and position calibration offset values that are calculated, and autonomously changing movement of the asset or an attachment of the asset using the additional first point cloud data that is modified and the additional second point cloud data that is modified to one or more of avoid colliding with an obstacle or grade a worksite.

The method also can include obtaining additional point cloud data from the first LiDAR sensor or the second LiDAR sensor while an arm of the asset or an attachment connected to the arm is within a field of view of the first LiDAR sensor or the second LiDAR sensor, filtering out first data points having reflectivity or signal values below a predetermined threshold associated with the arm of the asset from the additional point cloud data, and applying a box filter associated with the arm to the additional point cloud data with the first data points removed, the box filter applied to eliminate second data points from the additional point cloud data that are not associated with the arm.

The embodiments disclosed herein are intended to encompass a wide range of modifications, substitutions, and rearrangements that would be apparent to those skilled in the art. Such variations are considered to fall within the scope of the disclosed subject matter. For example, the described calibration and setup techniques may be adapted for use with different types of construction vehicles, sensor suites, or attachment geometries, and may be implemented using alternative hardware, software, or user interface configurations without departing from the spirit of the invention. Certain well-known elements, steps, or techniques may be omitted or described in less detail to avoid obscuring the underlying concepts. The specific features and sequences described in the following embodiments should not be construed as limiting, but rather as representative of the broader inventive concepts presented.

In this disclosure, the use of any and all examples or exemplary language (such as “for example”) is intended merely to better describe the embodiments and does not pose a limitation on the scope of all embodiments of the inventive subject matter. No language in the disclosure should be construed as indicating any non-claimed element essential to the practice of the inventive subject matter.

Also, the use of the terms “comprises,” “comprising,” or any other variation thereof, are intended to cover a non-exclusive inclusion, such that a system, device, or method that comprises a list of elements does not include only those elements, but may include other elements not expressly listed or inherent to such system, device, or method.

Further, the use of relative relational terms, such as first and second, are used solely to distinguish one unit or action from another unit or action without necessarily requiring or implying any actual such relationship or order between such units or actions.

Finally, while the inventive subject matter has been described and illustrated hereinabove with reference to various example embodiments, it should be understood that various modifications could be made to these embodiments without departing from the scope of the invention. Therefore, the inventive subject matter is not to be limited to the specific structural configurations or methodologies of the example embodiments, except insofar as such limitations are included in the following claims.

What is claimed is:

1. A computer-implemented method comprising:
receiving point cloud data from an optical sensor of a machine guidance system onboard an asset, the point cloud data representing a sensed environment that includes a portion of the asset and surrounding terrain;
transforming the point cloud data from a sensor coordinate frame to an asset coordinate frame;
applying different candidate pitch and roll offset values to the point cloud data;
generating a grid representation of the sensed environment for each of plural combinations of the candidate pitch and roll offset values;
calculating a calibration error for each of the combinations of the candidate pitch and roll offset values by comparing each of the grid representations to a reference surface; and
selecting a particular combination from the combinations exhibiting a smaller value of the calibration errors and applying the pitch and roll calibration values associated with the smaller value of the calibration errors to the point cloud data output by the optical sensor during subsequent operation of the asset.

2. The method of claim 1, further comprising:
receiving additional point cloud data from the optical sensor while the asset is at least partially autonomously performing material handling or earthmoving;
modifying the additional point cloud data using the pitch and roll calibration values that are selected; and
changing movement of the asset or an attachment of the asset using the additional point cloud data that is modified to one or more of autonomously avoid colliding with an obstacle or autonomously grade a worksite.

3. The method of claim 1, wherein the optical sensor is a first optical sensor, the point cloud data is first point cloud data, and further comprising:
receiving second point cloud data from a second optical sensor onboard the asset;
transforming the second point cloud data to the asset coordinate frame; and
calculating pitch, roll, yaw, and position calibration offset values for the second point cloud data by comparing the first point cloud data and the second point cloud data.

4. The method of claim 2, further comprising:
receiving additional first point cloud data from the first optical sensor and additional second point cloud data from the second optical sensor while the asset is at least partially autonomously performing material handling or earthmoving;
modifying the additional first point cloud data using the pitch and roll calibration values that are selected;
modifying the additional second point cloud data using the pitch, roll, yaw, and position calibration offset values that are calculated; and
changing movement of the asset or an attachment of the asset using the additional first point cloud data that is modified and the additional second point cloud data to one or more of autonomously avoid colliding with an obstacle or autonomously grade a worksite.

5. The method of claim 1, further comprising:
receiving, via an input device, vehicle data that specifies operating parameters for the asset, the operating parameters including one or more of a target grade, a vertical offset of the target grade, or a tolerance for the target grade,
wherein the operating parameters, the combination that is selected, and additional point cloud data from the optical sensor are used to autonomously control the asset during a grading operation.

6. The method of claim 1, further comprising:
applying one or more box filter constraints to the point cloud data output by the optical sensor, the one or more box filter constraints based on predetermined dimensions of the asset.

7. The method of claim 6, wherein applying the one or more box filter constraints includes removing data points within the point cloud data having a signal value below a predetermined threshold.

8. The method of claim 1, further comprising:
obtaining additional point cloud data from the optical sensor while an arm of the asset is within a field of view of the optical sensor;
filtering out first data points having reflectivity or signal values below a predetermined threshold associated with an arm of the asset from the additional point cloud data; and
applying a box filter associated with the arm to the additional point cloud data with the first data points removed, the box filter applied to eliminate second data points from the additional point cloud data that are not associated with the arm.

9. The method of claim 1, further comprising:
obtaining additional point cloud data from the optical sensor while an attachment is joined to an arm of the asset and the attachment is within a field of view of the optical sensor;
filtering out first data points having reflectivity or signal values below a predetermined threshold associated with the attachment from the additional point cloud data; and
applying a box filter associated with the attachment to the additional point cloud data with the first data points removed, the box filter applied to eliminate second data points from the additional point cloud data that are not associated with the attachment.

10. A machine guidance system comprising:
an optical sensor configured to be onboard a construction asset and to output point cloud data representative of a sensed environment that includes a portion of the asset and surrounding terrain; and
a processing unit configured to receive the point cloud data and transform the point cloud data from a sensor coordinate frame to an asset coordinate frame, the processing unit configured to apply different candidate pitch and roll offset values to the point cloud data, generate a grid representation of the sensed environment for each of plural combinations of the candidate pitch and roll offset values, and calculate a calibration error for each of the combinations of the candidate pitch and roll offset values by comparing each of the grid representations to a reference surface, the processing unit configured to select the combination exhibiting a smaller value of the calibration errors and apply the pitch and roll calibration values associated with the smaller value of the calibration errors to the point cloud data output by the optical sensor during subsequent operation of the asset.

11. The machine guidance system of claim 10, wherein the optical sensor is configured to output additional point cloud data while the asset is at least partially autonomously performing material handling or earthmoving, the processing unit configured to modify the additional point cloud data using the pitch and roll calibration values that are selected and to change movement of the asset or an attachment of the asset using the additional point cloud data that is modified to one or more of autonomously avoid colliding with an obstacle or autonomously grade a worksite.

12. The machine guidance system of claim 10, wherein the optical sensor is a first optical sensor, the point cloud data is first point cloud data, and further comprising:
a second optical sensor configured to be onboard the asset and to output second point cloud data, the processing unit configured to transform the second point cloud data to the asset coordinate frame and to calculate pitch, roll, yaw, and position calibration offset values for the second point cloud data by comparing the first point cloud data and the second point cloud data.

13. The machine guidance system of claim 12, wherein the first optical sensor is configured to output additional first point cloud data and the second optical sensor is configured to output additional second point cloud data while the asset is at least partially autonomously performing material handling or earthmoving, the processing unit configured to modify the additional first point cloud data using the pitch and roll calibration values that are selected and to modify the additional second point cloud data using the pitch, roll, yaw, and position calibration offset values that are calculated, the processing unit configured to change movement of the asset or an attachment of the asset using the additional first point cloud data that is modified and the additional second point cloud data to one or more of autonomously avoid colliding with an obstacle or autonomously grade a worksite.

14. The machine guidance system of claim 10, further comprising:
an input device configured to receive vehicle data that specifies operating parameters for the asset, the operating parameters including one or more of a target grade, a vertical offset of the target grade, or a tolerance for the target grade,
wherein the processing unit is configured to autonomously control the asset during a grading operation using the operating parameters, the combination that is selected, and additional point cloud data from the optical sensor.

15. The machine guidance system of claim 10, wherein the processing unit is configured to apply one or more box filter constraints to the point cloud data output by the optical sensor, the one or more box filter constraints based on predetermined dimensions of the asset.

16. The machine guidance system of claim 15, wherein the processing unit is configured to apply the one or more box filter constraints by removing data points within the point cloud data having a signal value below a predetermined threshold.

17. The machine guidance system of claim 10, wherein the processing unit is configured to obtain additional point cloud data from the optical sensor while an arm of the asset is within a field of view of the optical sensor, the processing unit configured to filter out first data points having reflectivity or signal values below a predetermined threshold associated with an arm of the asset from the additional point cloud data and apply a box filter associated with the arm to the additional point cloud data with the first data points removed, the box filter applied to eliminate second data points from the additional point cloud data that are not associated with the arm.

18. The machine guidance system of claim 10, wherein the processing unit is configured to obtain additional point cloud data from the optical sensor while an attachment is joined to an arm of the asset and the attachment is within a field of view of the optical sensor, the processing unit configured to filter out first data points having reflectivity or signal values below a predetermined threshold associated with the attachment from the additional point cloud data, the processing unit configured to apply a box filter associated with the attachment to the additional point cloud data with the first data points removed, the box filter applied to eliminate second data points from the additional point cloud data that are not associated with the attachment.

19. A computer-implemented method comprising:
receiving first point cloud data from a first LiDAR sensor onboard a construction asset and second point cloud data from a second LiDAR sensor onboard the asset, the first point cloud data and the second point cloud data representing a sensed environment that includes a portion of the asset and surrounding terrain;
transforming the first point cloud data and the second point cloud data from a sensor coordinate frame to an asset coordinate frame;
applying different candidate pitch and roll offset values to the first point cloud data;
generating a grid representation of the sensed environment for each of plural combinations of the candidate pitch and roll offset values;
calculating a calibration error for each of the combinations of the candidate pitch and roll offset values by comparing each of the grid representations to a reference surface;
selecting the combination exhibiting a smaller value of the calibration errors and applying the pitch and roll calibration values associated with the smaller value of the calibration errors to the first point cloud data output by the first LiDAR sensor during subsequent operation of the asset;
calculating pitch, roll, yaw, and position calibration offset values for the second point cloud data by comparing the first point cloud data and the second point cloud data;
receiving additional first point cloud data from the first LiDAR sensor and additional second point cloud data from the second LiDAR sensor while the asset is at least partially autonomously performing material handling or earthmoving;
modifying the additional first point cloud data using the pitch and roll calibration values that are selected;
modifying the additional second point cloud data using the pitch, roll, yaw, and position calibration offset values that are calculated; and
autonomously changing movement of the asset or an attachment of the asset using the additional first point cloud data that is modified and the additional second point cloud data that is modified to one or more of avoid colliding with an obstacle or grade a worksite.

20. The method of claim 19, further comprising:
obtaining additional point cloud data from the first LiDAR sensor or the second LiDAR sensor while an arm of the asset or an attachment connected to the arm is within a field of view of the first LiDAR sensor or the second LiDAR sensor;
filtering out first data points having reflectivity or signal values below a predetermined threshold associated with the arm of the asset from the additional point cloud data; and
applying a box filter associated with the arm to the additional point cloud data with the first data points removed, the box filter applied to eliminate second data points from the additional point cloud data that are not associated with the arm.
